(19) United States
(12) Patent Application Publication
(10) Pub. No.: US 2004/0229606 A1
(43) Pub. Date: Nov. 18, 2004

(54) Wireless apparatus, wireless terminal apparatus, wireless system, method of setting wireless system, computer apparatus, and computer program

(75) Inventors: Tomohiro Oshima, Fukuoka-shi (JP); Yasushi Yokomitsu, Chikushino-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/824,610

(22) Filed: Apr. 15, 2004

(30) Foreign Application Priority Data
Apr. 16, 2003 (JP) 2003-111139
Nov. 11, 2003 (JP) 2003-380910

(51) Int. Cl. H04Q 7/20; H04M 11/00

(52) U.S. Cl. 455/426.2; 455/422.1; 455/403

(57) ABSTRACT

A wireless apparatus capable of being communicated to a plurality of terminal apparatus by a wireless manner, is comprised of: a wire interface for being communicated to the terminal apparatus by a wire manner; and control means for controlling a setting mode in which when the control means receives a transmit packet from the terminal apparatus connected to the wire interface and the transmit packet contains an address specific to the terminal apparatus, wireless setting information and/or network setting information are transmitted with respect to the terminal apparatus of the specific address. A wireless apparatus and a wireless terminal apparatus can be provided, which are known as a router apparatus, which are capable of easily setting a wireless unit such as SSID and an encryption system, and also capable of readily setting a network which contains the setting operation of the wireless unit.

### BACKGROUND OF THE INVENTION

The present invention is related to a wireless apparatus and a wireless terminal apparatus capable of automatically setting wireless communication conditions among wireless apparatus used in a network such as a LAN, and related to a computer apparatus and a computer program, and also, related to a method of setting a wireless system.

Generally speaking, constructions of network systems using LANs (Local area Networks) have been recently popularized.

Normally, in order that terminal apparatus are connected to a LAN, IP addresses and the like are required to be set. However, when such an IP address setting operation is carried out, since expertise as to networks must be necessarily required, there are many difficult opportunities, that is to say, users cannot easily set these setting data. Under such a circumstance, an IP protocol therefore owns such a DHCP (Dynamic Host Configuration Protocol) function. In accordance with this DHCP function, such a method can be taken. That is, IP addresses can be set by merely connecting terminal apparatus to a network, and then can be managed in a batch manner. As this DHCP function, there are an allocation mode for automatically allocating IP addresses to terminal apparatus in a permanent manner (similar to BOOTP), and also, another allocation mode for allocating IP addresses to terminal apparatus only during a limited time period, or until the terminal apparatus are released. For instance, in such a case that a private network is constituted by a plurality of terminal apparatus and a router apparatus, the router apparatus is arranged as a DHCP server, whereas these plural terminal apparatus are arranged as DHCP clients respectively. As a result, when a terminal apparatus is connected to the router apparatus, since a DHCP discovering packet is transmitted from the terminal apparatus, an IP address, a sub-net mask, and an address of a DNS server can be set from the router apparatus. It is described in, for example, JP-A-2000-92107.

However, since an automatic setting operation as to IP addresses by way of the DHCP function is carried out by accessing via a hub and a router to a DHCP server, in such a case that a terminal apparatus corresponds to a wireless terminal apparatus having a function such as a wireless LAN, if such a condition as an SSID and an encryption system of this wireless terminal apparatus is different from a condition owned by an access point (e.g., router apparatus), then this wireless terminal apparatus cannot be communicated to the access point. As a consequence, first of all, a user of a wireless terminal apparatus investigates setting contents such as an SSID and an encryption system, which have been set to a wireless access point such as a wireless router apparatus. Then, this user is required to set the same setting contents (SSID and encryption system) as those of the wireless access point into the own wireless terminal apparatus. In this setting operation, since the user necessarily requires the expertise as to the networks, there are many difficult cases such that the user cannot readily set these setting contents to the wireless terminal apparatus.

### SUMMARY OF THE INVENTION

The present invention has been made to solve the above-described problems of the conventional techniques, and therefore, has an object to provide a wireless apparatus and a wireless terminal apparatus, which are known as a router apparatus, capable of easily setting a wireless unit such as an SSID and an encryption system, and also capable of readily setting a network which contains the setting operation of the wireless unit.

To solve the above-explained conventional problems, a wireless apparatus, according to the present invention, is featured by such a wireless apparatus capable of being communicated to a plurality of terminal apparatus by a wireless manner, comprising: a wire interface for being communicated to the terminal apparatus by a wire manner; and control means for controlling a setting mode in which when the control means receives a transmit packet from the terminal apparatus connected to the wire interface and the transmit packet contains an address specific to the terminal apparatus, wireless setting information and/or network setting information are transmitted with respect to the terminal apparatus of the specific address. As a consequence, both a wireless apparatus and a wireless terminal apparatus, known as a router apparatus, can be provided by which wireless units as to SSIDs and encryption systems can be easily set, and networks containing these wireless units can be readily set.

### BRIEF DESCRIPTION OF THE DRAWINGS

FIG. 1 is a structural diagram of a wireless system according to an embodiment mode 1 of the present invention.

FIG. 2 is an internal structural diagram of a router apparatus according to the embodiment mode 1 of the present invention.

FIG. 3 is a structural diagram of a wireless adaptor apparatus according to the embodiment mode 1 of the present invention.

FIG. 4 is a structural diagram of a wireless image server apparatus according to the embodiment mode 1 of the present invention.

FIG. 5 is a diagram for representing a connection established in such a case that wireless setting information between the router apparatus and the wireless adaptor apparatus (otherwise, wireless image server apparatus) is automatically set according to the embodiment mode 1 of the present invention.

FIG. 6 is a diagram for indicating a structure of a transmission packet which is employed in order to automatically set the wireless setting information in the embodiment mode 1 of the present invention.

FIG. 7 is a sequence chart for indicating an automatic setting operation of setting information as to the wireless image server apparatus according to the embodiment mode 1 of the present invention.

FIG. 8 is a sequence chart for indicating an automatic setting operation of setting information as to the wireless adaptor apparatus according to the embodiment mode 1 of the present invention.

FIG. 9 is a diagram for representing a content of a network setting information which is stored in a storage means of the router apparatus according to the embodiment mode 1 of the present invention.

FIG. 10 is a flow chart for describing operation of the router apparatus operated in an automatic setting mode, according to the embodiment mode 1 of the present invention.

FIG. 11 is a flow chart for explaining a setting-information automatic producing operation of the router apparatus operated in the automatic setting mode, according to the embodiment mode 1 of the present invention.

FIG. 12 is another flow chart for explaining a setting-information automatic producing operation of the router apparatus operated in the automatic setting mode, according to the embodiment mode 1 of the present invention.

FIG. 13 is a flow chart for describing operation of the wireless image server apparatus operated in an automatic setting mode, according to the embodiment mode 1 of the present invention.

FIG. 14 is a structural diagram for indicating a network system according to an embodiment mode 2 of the present invention.

FIG. 15 is an internal structural diagram of a router apparatus according to the embodiment mode 2 of the present invention.

FIG. 16 is a structural diagram of a computer apparatus according to the embodiment mode 2 of the present invention.

FIG. 17 is a structural diagram of the computer apparatus which containing a wireless LAN unit, according to the embodiment mode 2 of the present invention.

FIG. 18 is a diagram for representing a construction of a UDP packet of setting information which is transmitted from the router apparatus, according to the embodiment mode 2 of the present invention.

FIG. 19 is a diagram for showing a content of a network setting information of the router apparatus according to the embodiment mode 2 of the present invention.

FIG. 20 is a diagram for representing an operation sequence of the computer apparatus according to the embodiment mode 2 of the present invention.

FIG. 21 is a diagram for showing a connection construction of the computer apparatus during information setting operation, according to the embodiment mode 2 of the present invention.

FIG. 22 is an operation flow chart of the router apparatus according to the embodiment mode 2 of the present invention.

FIG. 23 is an operation flow chart of the computer apparatus according to the embodiment mode 2 of the present invention.

### DETAILED DESCRIPTION OF THE PREFERRED EMBODIMENTS

Referring now to drawings, embodiment modes of the present invention will be described.

### Embodiment Mode 1

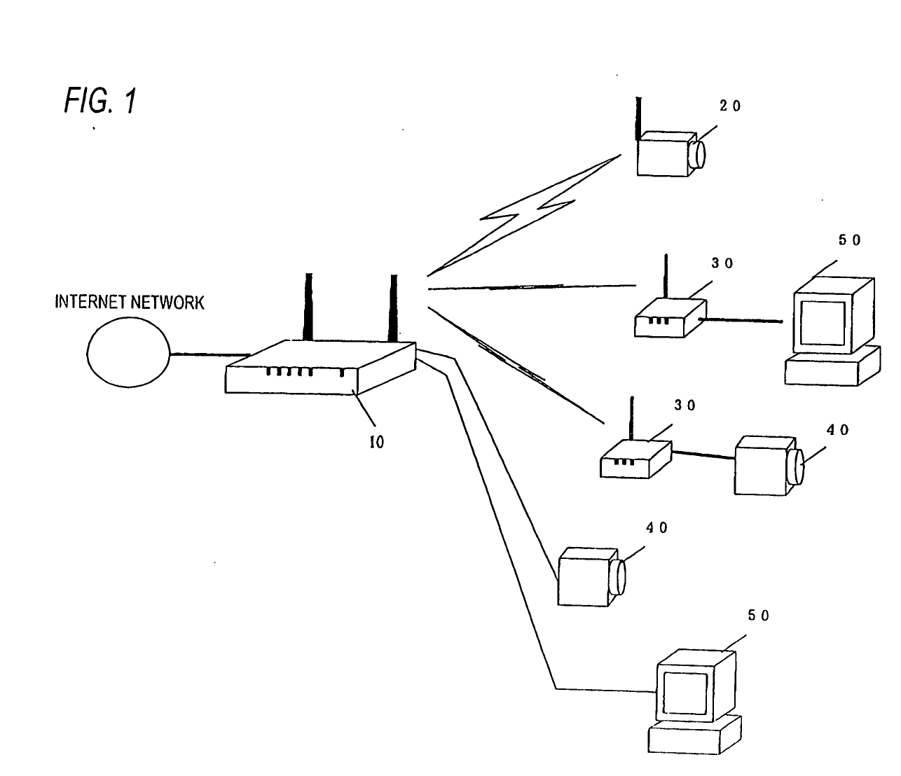

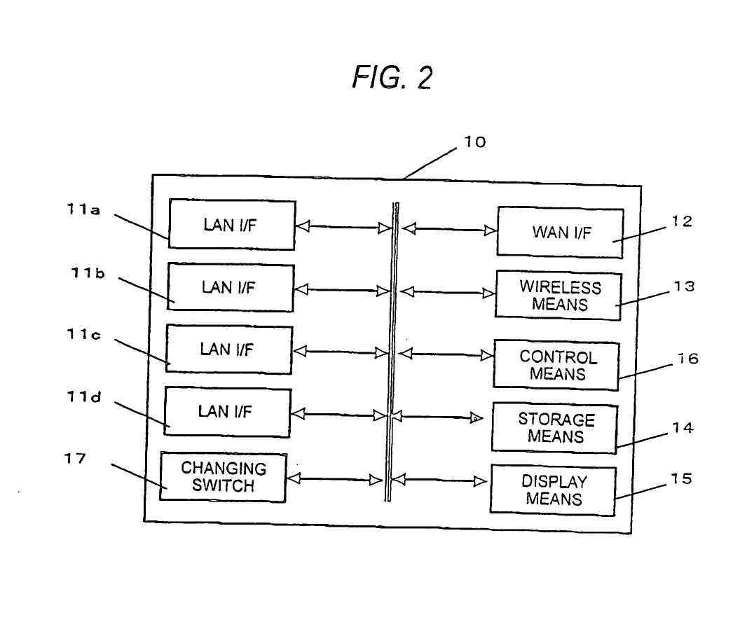

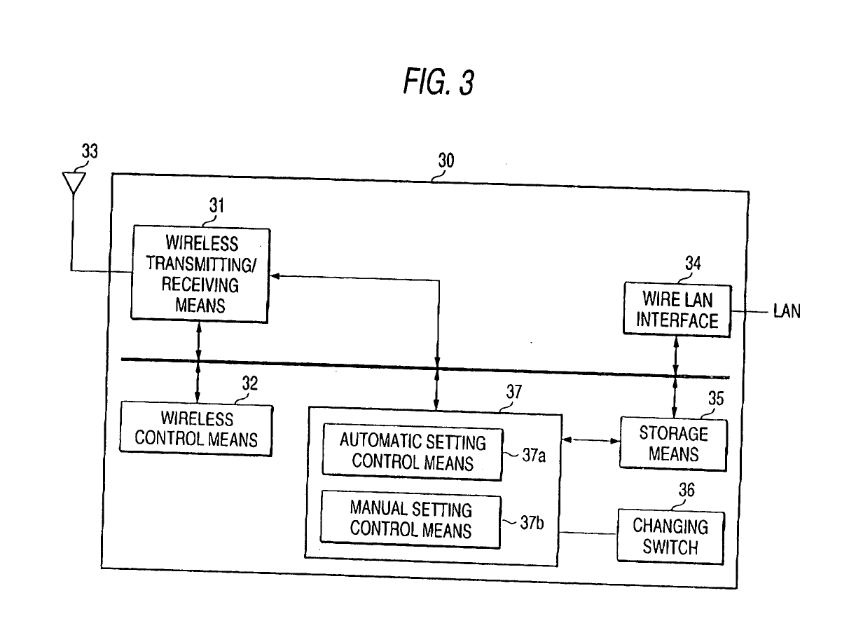

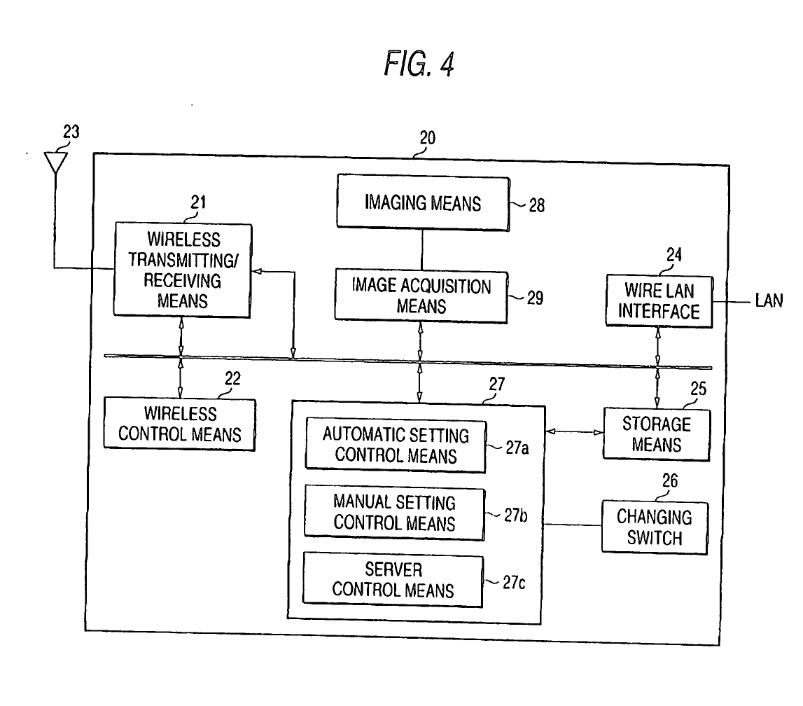

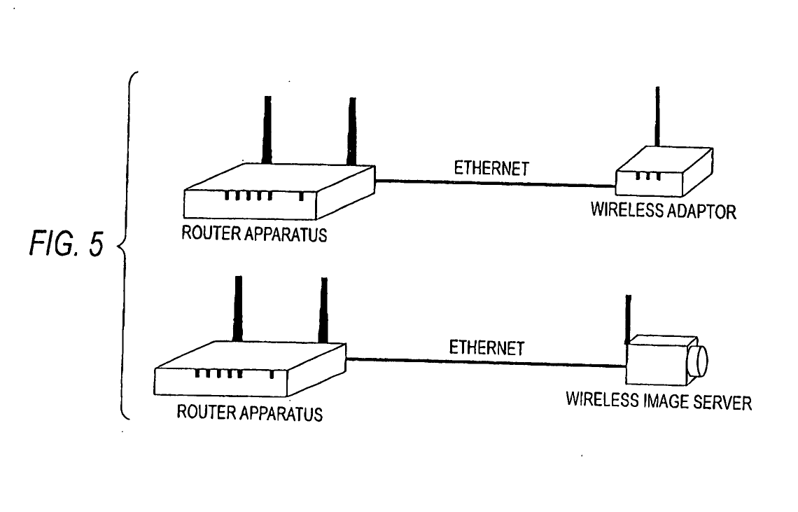

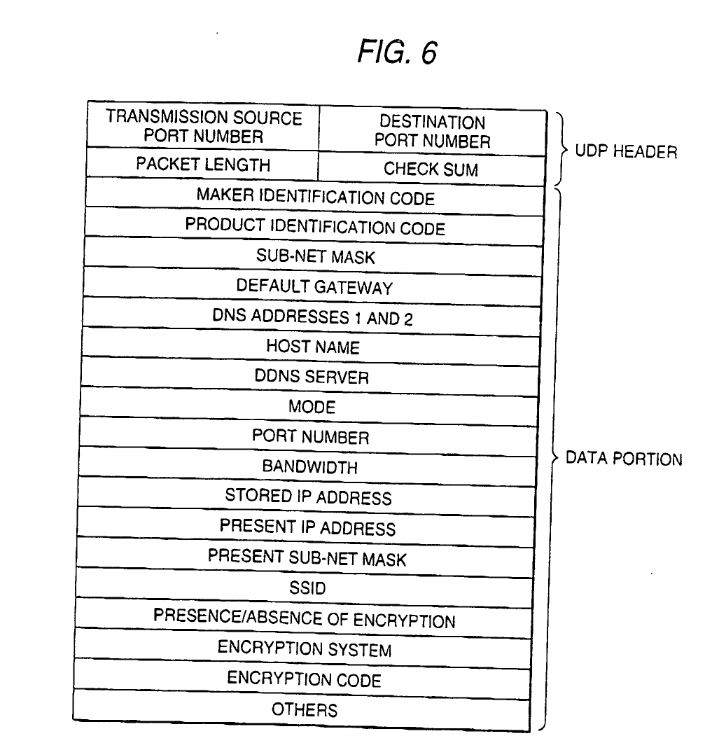

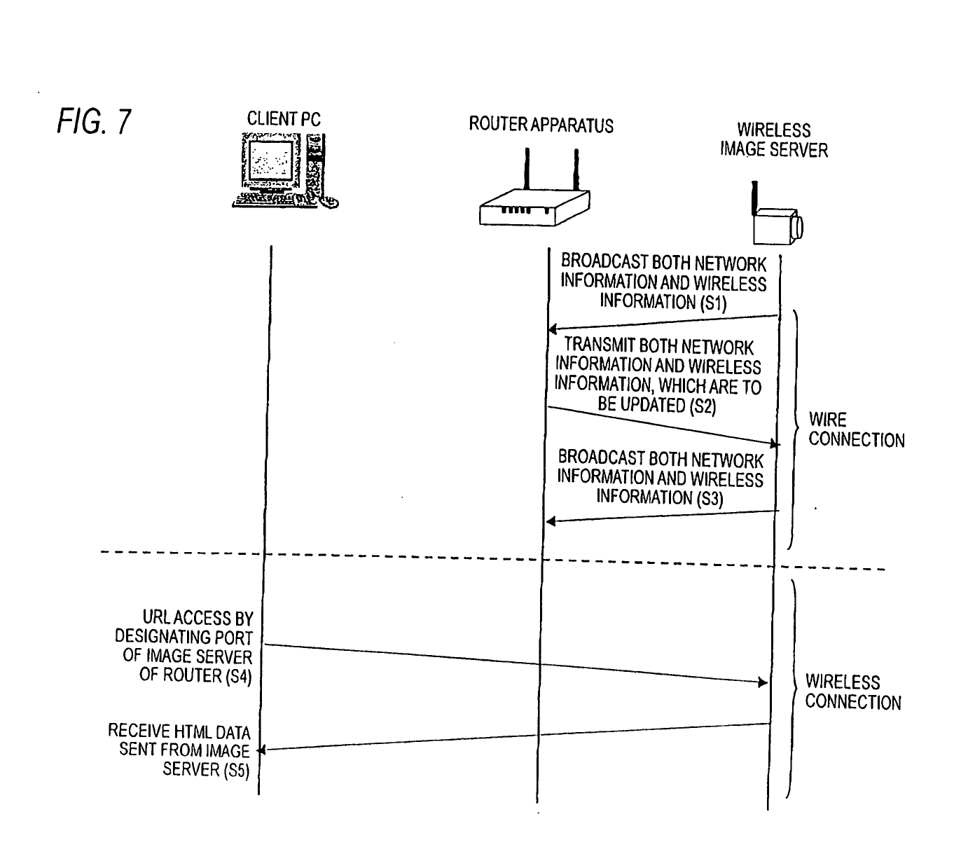

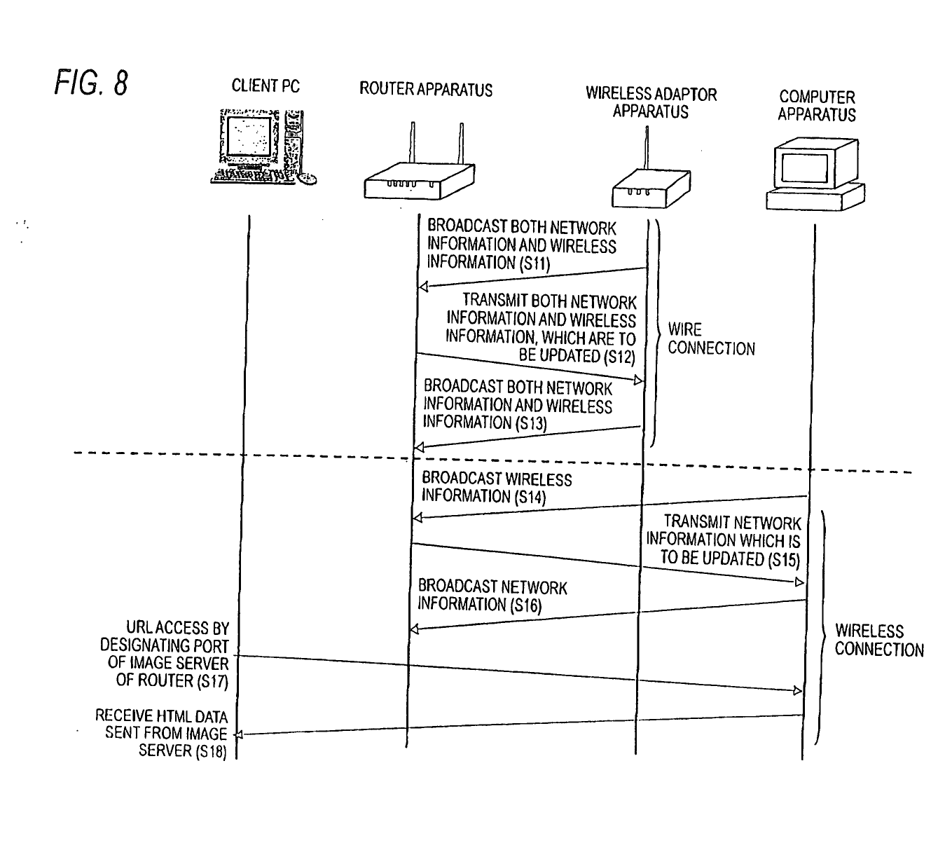

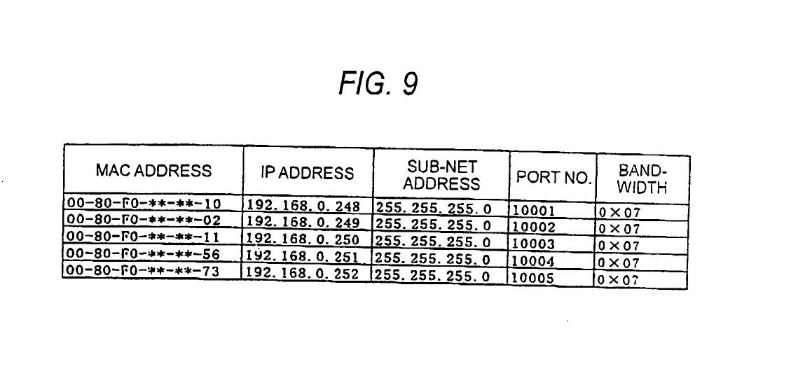

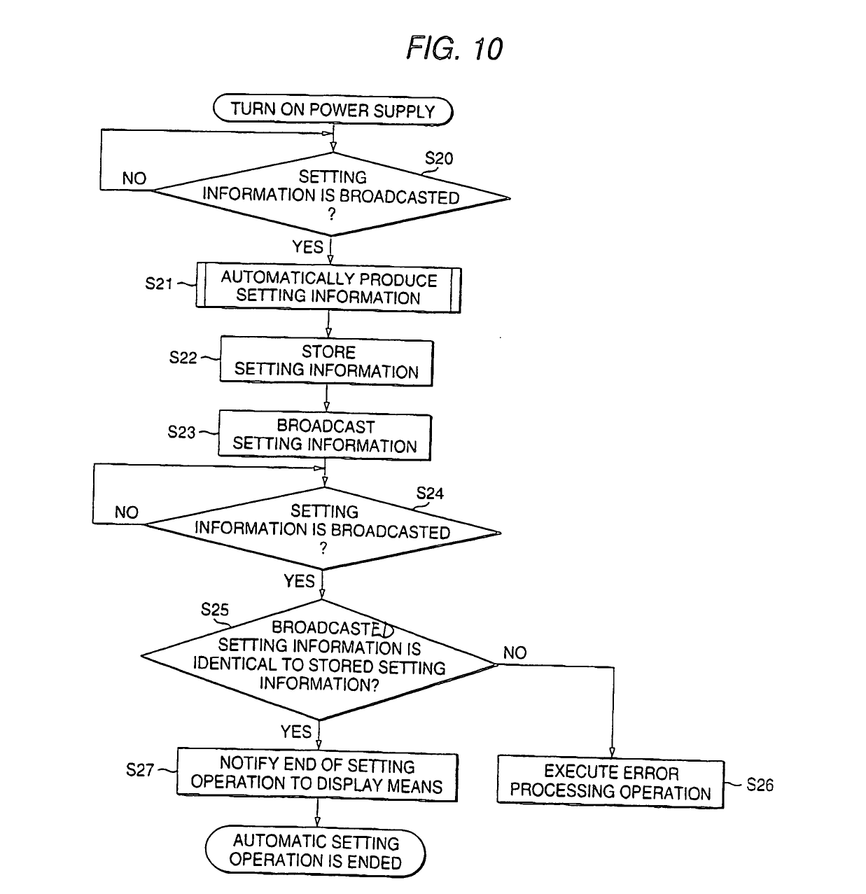

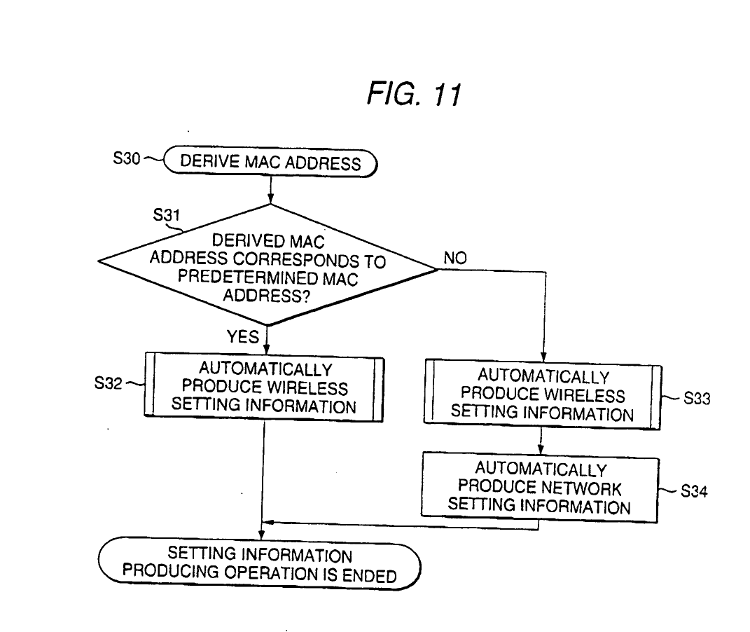

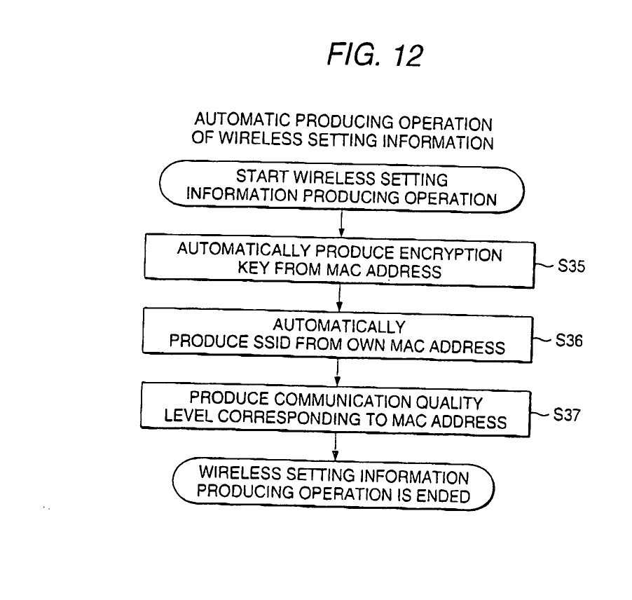

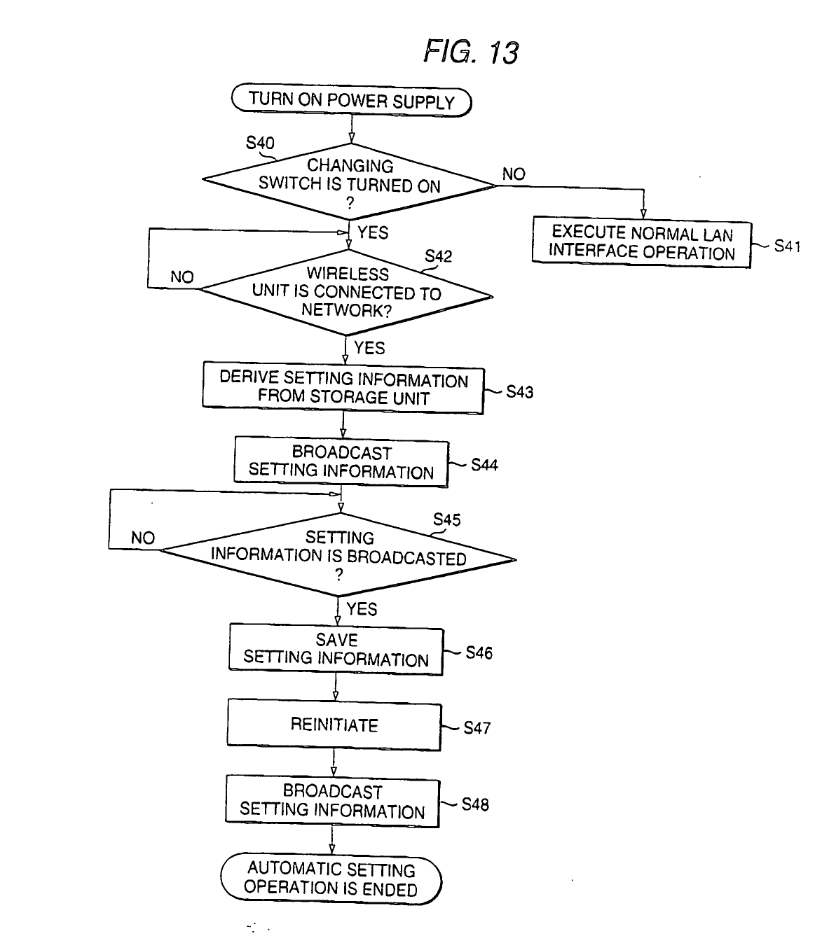

FIG. 1 is a structural diagram of a wireless system according to an embodiment model of the present invention. FIG. 2 is an internal structural diagram of a route apparatus according of the embodiment mode 1 of the present invention. FIG. 3 is a structural diagram of a wireless adaptor apparatus according to the embodiment mode 1 of the present invention. FIG. 4 is a structural diagram of a wireless image server apparatus according to the embodiment mode 1 of the present invention. FIG. 5 is a diagram for representing a connection established in such a case that wireless setting information between the router apparatus and the wireless adaptor apparatus (otherwise, wireless image server apparatus) is automatically set according to the embodiment mode 1 of the present invention. FIG. 6 is a diagram for indicating a structure of a transmission packet which is employed in order to automatically set the wireless setting information in the embodiment mode 1 of the present invention. FIG. 7 is a sequence chart for indicating an automatic setting operation of setting information as to the wireless image server apparatus according to the embodiment, mode 1 of the present invention. FIG. 8 is a sequence chart for indicating an automatic setting operation of setting information as to the wireless adaptor apparatus according to the embodiment mode 1 of the present invention. FIG. 9 is a diagram for representing a content of a network setting information which is stored in a storage means of the router apparatus according to the embodiment mode 1 of the present invention. FIG. 10, FIG. 11, and FIG. 12 are flow charts for describing operations of the router apparatus operated in an automatic setting mode, according to the embodiment mode 1 of the present invention. FIG. 13 is a flow chart for explaining operation of the wireless image apparatus operated in the automatic setting mode, according to the embodiment mode 1 of the present invention.

In FIG. 1, reference numeral 10 shows a router apparatus (namely, wireless apparatus of the present invention), and reference numeral 20 indicates a wireless image server apparatus (namely, wireless terminal apparatus of the present invention) The wireless image server apparatus 20 establishes a communication link between the router apparatus 10 and the own wireless image server apparatus 20 by using a wireless protocol (protocol applicable to technical specification such as IEEE802.11b), and corresponds to, for example, a network camera capable of performing a data communication on this established communication link by way of the UDP protocol and the TCP/IP protocol. Reference numeral 30 represents a wireless adaptor apparatus (namely, wireless terminal apparatus of the present invention) which relays a communication between the router apparatus 10 and a computer apparatus 50 (or, wire image server apparatus 40). While the wireless adaptor apparatus 30 establishes a communication link between the router apparatus 10 and the own wireless adaptor apparatus 30 by using a wireless protocol, or the like, this wireless adaptor apparatus 30 executes a data communication on this communication link by using the TCP/IP protocol, or the like, and, on the other hand, executes a data communication between the computer apparatus 50 and the wire image server apparatus 40 via a wire cable such as 100BASE-T by using the TCP/IP protocol.

Reference numeral 40 shows a wire image server apparatus such as a network camera capable of executing a data communication by employing the UDP protocol, or the TCP/IP protocol in a wire system such as the Ethernet. Reference numeral 50 is a computer apparatus such as a personal computer, which installs a browser, and is capable of executing a data communication by employing the UDP protocol, or the TCP/IP protocol in a wire system such as the Ethernet.

In this case, both the wire image server apparatus 40 and the computer apparatus 50 own wire interfaces capable of being connected to a wire LAN, or the like, and can be connected to the router apparatus 10 and the wireless adaptor apparatus 30.

It should be understood that both the wire image server apparatus 40 and the wireless image server apparatus 20 own such a function that image data imaged by an imaging means and a Web page containing this image data are transmitted in response to an access operation made by the Internet, and a local network. Also, such an apparatus involving the wireless image server apparatus 20 and the wireless adaptor apparatus 30 will be referred to as a “wireless terminal apparatus” hereinafter.

In FIG. 2, reference numerals 11a to 11d show wire LAN interfaces used to be communicated to a terminal apparatus which constitutes a private network. The wire LAN interfaces are adapted to such a LAN specification as IEEE802.3 (CSMA/CD), and correspond to interfaces capable of being connected to such a cable as 100BASE-T. Reference numeral 12 indicates a WAN interface used to be communicated to an external network such as the Internet. This WAN interface 12 is adapted to such a LAN specification as the Ethernet and IEEE802.3 (CSMA/CD) and corresponds to an interface capable of being connected to such a cable as 100BASE-T. It should also be noted that the WAN interface 12 may be realized by another interface which is communicatable with ADSL and ISDN other than an interface adaptable with the LAN specification. Also, the router apparatus 10 may transfer a packet received by the WAN interface 12 to a terminal apparatus which is connected to the wire LAN interface 11 by way of a port forward function, and conversely, may convert a packet which is transmitted from the terminal apparatus into an IP address by way of a NAT function, and then, may transfer this IP address to an external network. Also, the terminal apparatus which is connected to the wire LAN interface 11 constitutes a private network, and can be communicated among respective terminals by employing local IP addresses. It should also be noted that a port forward function is carried out by employing a port number which has been set by an automatic setting operation (will be explained later).

Reference numeral 13 shows a wireless means. This wireless means 13 contains a wireless LAN interface used to be communicated to a terminal apparatus which constitutes a private network, and is adapted to such a wireless LAN specification as the Ethernet, or IEEE802.11, and also is communicated to the terminal apparatus in a wireless manner.

Reference numeral 14 represents a storage means for storing therein to a control program and various sorts of setting information, and also, storing therein to network setting information of various terminal apparatus, wireless setting information, and the like.

Reference numeral 15 shows a display means such as an LCD and an LED. Reference numeral 16 denotes a control means for controlling an entire system of a wireless apparatus, and reference numeral 17 represents a changing switch for switching an automatic setting mode (will be explained later) and the normal LAN operation mode.

It should also be understood that the control means 16 connects a communication link with respect to a terminal apparatus by employing a wireless protocol, and performs a data communication operation on this communication link by using the UDP protocol, or the TCP/IP protocol.

In FIG. 3, reference numeral 31 represents a wireless transmitting/receiving means. This wireless transmitting/receiving means 31 owns a wireless LAN interface used to be communicated to the router apparatus 10 by the using a wireless protocol, and performs a connection of a communication link with respect to a terminal apparatus in a wireless manner in such a form which can be adapted to such a wireless LAN specification as IEEE802.11.

Reference numeral 32 shows a wireless control means for controlling the wireless transmitting/receiving means 31. Reference numeral 33 represents an antenna used to transmit and receive a wireless signal, and is connected to the wireless transmitting/receiving means 31. Reference numeral 34 shows a wire LAN interface used to be communicated to the wireless apparatus 10, the computer apparatus 50, and the wire image server apparatus 40. This wire LAN interface 34 corresponds to an interface which can be adapted to such a LAN specification as IEEE802.3 (CSMA/CD), and can be connected to such a cable as 100BASE-T. Reference numeral 35 indicates a storage means For storing therein to various sorts of setting information.

Reference numeral 36 indicates a changing switch for switching an automatic setting mode (will be explained later), a manual setting mode (will be explained later), and the normal LAN operation mode. In this case, the changing switch 36 may be realized by not only a mechanical switch, but also such a switch for switching modes via a LAN interface in a software manner.

Reference numeral 37 indicates a control means for controlling an entire system of the wireless terminal apparatus 30 as follows. That is, the control means 37 controls the wireless control means 32 so as to connect a wireless communication link with respect to the router apparatus 10, and also, in order that the control means 37 can be communicated to another terminal apparatus via the router apparatus 10 by using the UDP protocol, or the TCP/IP protocol, and also, the control means 37 is communicated to the computer apparatus 50, or the like via the wire LAN interface 34 by way of the UDP protocol, or the TCP/IP protocol.

Reference numeral 37a represents an automatic setting control means for controlling operations of the automatic setting mode as follows: That is, in the case that the operation mode of the wireless terminal apparatus 30 is switched to the automatic setting mode by operating the changing switch 36, this automatic setting control means 37a receives various sorts of wireless setting information such as the SSID and encryption information via the wire LAN interface 34 from the router apparatus 10, and then stores this received wireless setting information into the storage means 35.

Reference numeral 37b shows a manual setting control means for controlling operations of the manual setting mode in the case that the operation mode of the wireless terminal apparatus 30 is switched to the manual setting mode by operating the changing switch 36. Under such a condition that the computer apparatus 50 is connected to the wireless terminal apparatus 30, in such a case that an access operation is made via the wire LAN interface 34 to the wireless terminal apparatus 30by operating the computer apparatus 50 by a user, this manual setting control means 37b derives a Web page for the manual setting operation from the storage means 35, and then transmits the derived Web page to the computer apparatus 50. Also, when various sorts of wireless setting information such as the SSID and encryption information is set by the user of the computer apparatus 50 on the transmitted Web page (which is displayed on display screen of computer apparatus 50), this manual setting control means 37b receives the wireless setting information transmitted from the computer apparatus 50, and then stores this received wireless setting information into the storage means 35.

In FIG. 4, reference numeral 21 shows a wireless transmitting/receiving means having a wireless LAN interface used to be communicated to the router apparatus 10 which constitutes a private network. This wireless transmitting/receiving means 21 performs a wireless transmission/reception by employing a connection of a communication link with the router apparatus 10 in a form which can be adapted to such a wireless LAN specification as the wireless specification of IEEE802.11. In this case, a communication between the wireless transmitting/receiving means 21 and the router apparatus 10 may be carried out even via the wireless LAN interface 24, or even through the wireless transmitting/receiving means 21. In the case that a communication connection is set by a user, or the wire LAN interface 24 is connected to the router apparatus 10, a communication operation via this wire LAN interface 24 may be carried out in a top priority. When the wire LAN interface 24 is not connected to the router apparatus 10, a communication operation in the wireless transmitting/receiving means 21 may be carried out in a top priority.

Reference numeral 22 shows a wireless control means for controlling the wireless transmitting/receiving means 21. Reference numeral 23 represents an antenna used to transmit and receive a wireless signal, while being connected to the wireless transmitting/receiving means 21. Reference numeral 24 shows a wire LAN interface used to be communicated to the router apparatus 10. This wire LAN interface 24 corresponds to an interface which can be adapted to such a LAN specification as IEEE802.3 (CSMA/CD), and can be connected to such a cable as 100BASE-T. Reference numeral 25 indicates a storage means for storing therein to various sorts of setting information.

Reference numeral 26 indicates a changing switch for switching an automatic setting mode (will be explained later), a manual setting mode, and the normal LAN operation mode. In this case, the changing switch 26 may be realized by not only a mechanical switch, but also such a switch for switching modes via a LAN interface in a software manner.

Reference numeral 27 indicates a control means for controlling an entire system of the wireless image server apparatus 20 as follows. That is, the control means 27 controls the wireless control means 22 so as to connect a wireless communication link with respect to the router apparatus 10, and also, in order that The control means 27 can be communicated to another terminal apparatus via the router apparatus 10 by using the TCP/IP protocol, and also, the control means 27 is communicated to the router apparatus 10 via the wire LAN interface 24 by way of the TCP/IP protocol.

Reference numeral 27a represents an automatic setting control means for controlling operations of the automatic setting mode as follows: That is, in the case that the operation mode of the wireless image server apparatus 20 is switched to the automatic setting mode by operating the changing switch 26, this automatic setting control means 27a receives various sorts of wireless setting information such as the SSID and encryption information via the wire LAN interface 24 from the router apparatus 10, and then stores this received wireless setting information into the storage means 25.

Reference numeral 27b shows a manual setting control means for controlling operations of the manual setting mode in the case that the operation mode of the wireless terminal apparatus 30 is switched to the manual setting mode by operating the changing switch 26. Under such a condition that the computer apparatus 50 is connected to the wireless terminal apparatus 30, in such a case that an access operation is made via the wire LAN interface 24 to the wireless terminal apparatus 30 by operating the computer apparatus by a user, this manual setting control means 27b derives a Web page for the manual setting operation from the storage means 25, and then transmits the derived Web page to the computer apparatus 50. Also, when various sorts of wireless setting information such as the SSID and encryption information is set by the user of the computer apparatus 50 on the transmitted Web page (which is displayed on display screen of computer apparatus 50), this manual setting control means 27b receives the wireless setting information transmitted from the computer apparatus 50, and then stores this received wireless setting information into the storage means 25.

Reference numeral 27c shows a server control means which performs a control operation. That is to say, this server control means 27c transmits image data imaged by an imaging means 28 and a Web page containing this image data with respect to an access issued from the Internet and/or a local network.

Reference numeral 28 represents an imaging means. Also, reference numeral 29 indicates an image acquiring means which converts a format of image data imaged by the imaging means 28 into a predetermined format such as the JPEG thereof. The control means 26 also performs such a control operation that the image data acquired by the image acquiring means 28 is stored in the storage means 24, and/or this acquired image data is transmitted to a client terminal, or the like, which are connected to a network.

With respect to the wireless apparatus (router apparatus 10) according to the present invention, which is arranged in the above-described manner, an automatic setting operation as to both wireless setting information and network setting information of the wireless image server apparatus 20 will new be firstly described with reference to a sequence diagram of FIG. 7.

In order to perform operations in the automatic setting mode, first of all, the operation mode of the wire LAN interface 11a is switched to the automatic setting mode by operating the switching means 17 of the router apparatus 10. Also, the operation mode of the wire LAN interface 24 is switched to the automatic setting mode by operating the switching means 26 of the wireless image server apparatus 20. Then, as shown in FIG. 5, both the wire LAN interface 11a of the wireless apparatus 10 and the wire LAN interface 24 of the wireless image server apparatus 20 are connected to each other by way of such a cable as 100BASE-T.

Under this condition, when the own power supply of the wireless image server apparatus 20 is turned ON, a reset switch thereof is depressed, or the wireless image server apparatus 20 is connected to a private network, the wireless image server apparatus 20 broadcasts a transmission packet with respect to the private network for a predetermined time period (in this case, 30 minutes are predetermined) in a constant interval by way of the UDP protocol (S1). The transmission packet contains a content of setting such wireless setting information as the SSID and the encryption information in addition to network setting information such as an IP address and a port number of a wireless terminal apparatus at a transmission time instant. It should be noted that this transmission packet to be broadcasted is constituted by a UDP header portion and a data portion as shown in FIG. 6. The data portion is arranged by a maker identification code which is employed so as to identify a maker of the wireless image server apparatus 20; a product identification code which is employed so as to identify a product sort and various information of the wireless image server apparatus 20; various sorts of data (network setting information) which are required to be connected to a network, such as an IP address, a sub-net mask, a DNS server, a gateway, and a port number, which have been set to the wireless image server apparatus 20; and also, various data (wireless setting information) related to wireless setting operation such as the SSID, an encryption method, and an encryption code.

Also, as a destination port of the UDP header portion, such a number (namely, 10667 in this case) except for the well-known port numbers 0 to 1023 is used. It should also be noted that both the network setting information and the wireless setting information have been stored in the storage means 25 of the wireless image server apparatus 20 In such a case that the wireless image server apparatus 20 is set to an initial condition, since either “FFFF---” or “0000---” have been stored in the storage means 25, this data is inserted into the data portion so as to produce a transmission packet, and then this transmission packet is transmitted.

The transmission packet which is broadcasted by the wireless image server apparatus 20 is received by the router apparatus 10. When the router apparatus 10 judges that the destination port of this transmission packet corresponds to the predetermined port number “10667”, the router apparatus 10 recognizes that a request for an automatic setting operation is issued from the wireless image server apparatus 20, and then, commences the automatic setting operation. In this automatic setting operation, the router apparatus 10 firstly judges as to whether or not a transmission source MAC address which is contained in a data link layer of the transmission packet is present in the storage means 14. If the transmission source MAC address is not present in the storage means 14, then the router apparatus 10 executes a new setting operation.

On the other hand, in such a case that the transmission source MAC address has been present in the storage means 14, the router apparatus 10 executes an update confirmation operation.

It should be noted that the control means 16 judges as to whether or not (1) only the wireless setting information is transmitted from the transmission source MAC address; as to whether or not (2) only the network setting information is transmitted therefrom; or as to whether or not both the wireless setting information and the network setting information are transmitted therefrom. Since the wireless image server apparatus 20 is such an apparatus which is operated as not only a wireless means, but also a terminal of a private network, the control means 16 determines that both the wireless setting information and the network setting information are transmitted. It should also be noted that the judging operations as to the above-described items (1) to (3) are carried out based upon a content stored in the storage means 14 (both a portion of MAC address and information to beset are previously stored in storage means 14 in correspondence with each other). A portion of the MAC address corresponds to either only the maker identification information or both the maker identification information and a portion of the internal maker-specified identification information.

Also, the information to be transmitted (namely, above-described items (1) to (3)) has been previously stored in the storage means 14 in correspondence with each other with respect to the MAC address. However, the control means 16 accesses a predetermined server on a network in a periodic manner so as to download a content as to the information which should be transmitted with respect to the MAC address and then stores the downloaded information into the storage means 14.

In this case, a new setting operation is explained in such a manner that this new setting operation is constituted by two sorts of setting operations, namely, a setting operation of network information and another setting operation of wireless information. Alternatively, the setting informations between the router apparatus 10 and the wireless image server apparatus 20 may be set in a collecting manner.

The network information is set in such a manner that after values of an IP address, a sub-net mask, a port number, and a bandwidth among data contained in a data portion of a received transmission packet have been changed by an automatic setting control unit, the changed data are stored in a storage unit in combination with data related to setting operation of another network. These values are changed in such a manner that the IP address becomes such a value of an IP address which is not used within the IP addresses of a predetermined range; the sub-net mask becomes a predetermined value (in this case, 255.255.255.0); the port number becomes such a port number which is not used within a predetermined range (in this case, 10001 to 10020) and also, the value of the bandwidth becomes a predetermined value. The values which had been set in the above-described manner have been stored in the storage means in relation to each of the MAC addresses of the respective terminal apparatus (namely, image server apparatus 20 and 40, wireless adaptor apparatus 30, and the like) as shown in FIG. 9. It should be understood that in FIG. 9, for the sake of simple explanations, the maker identification code, the DNS server and the like are omitted. Also, the bandwidth corresponds to such a data transfer speed at which the wireless image server apparatus 20 sends out data to a network, and this bandwidth may be defined by considering a traffic.

Also, the wireless information is set in such a manner that after an SSID, presence/absence of encryption, an encryption method, and a value of an encryption code among the data contained in the data portion of the received transmission packet are changed by the automatic setting control unit, the changed values are stored in the storage unit. The changing operation of the values are carried out based upon a MAC address of a wireless apparatus. Concretely speaking, since the control means 16 of the router apparatus 10 derives a MAC address of the own apparatus and performs a predetermined calculating operation, a result of this calculation is used as a value which should be changed. Since a MAC address is a unique address, an SSID, an encryption code, and the like are automatically produced which are different with respect to each of the router apparatus 10, and are used in a wireless communication. The values which have been changed in the above-described manner are stored in the storage means as wireless setting information. It should also be noted that as to the encryption code, the value of this encryption code may be alternatively changed based upon the transmission source MAC address.

Also, a terminal apparatus which performs an automatic setting operation judges that how degree a communication quality should be secured based upon a transmission source MAC address, and a level of this communication quality is stored in the storage means 14. Concretely speaking, while a portion (either only maker identification information or both maker identification information and a portion of internal maker specific identification information) of a MAC address has been previously stored in the storage means 14 in relation to an image quality level, a communication level of a terminal apparatus for performing an automatic setting operation is determined in accordance with the content of this storage means.

After the value of the network setting information and the value of the wireless setting information are stored in the storage means 14, the network setting information containing the value stored in the storage means 14 is contained in a transmission packet, and then, this transmission packet is transmitted by using the UDP protocol, while the MAC address stored in the storage means 14 is designated (S2) It should also be noted that as to the destination port of the UDP header portion, such a number (in this case, 10668) except for the well-known port numbers 0 to 1023 and 10667 is used. The transmission packet which has been broadcasted from the router apparatus 10 is received via the wire LAN interface 11 by the wireless image server apparatus 20. When it is so judged that the destination port corresponds to a preselected port number 10668, the wireless image server apparatus 20 recognizes that this transmission packet responds to time automatic setting operation from the router apparatus 10, and then stores the setting information which will be sent into the storage means 25 of the wireless image server apparatus 20. It should also be noted that in such a case that a predetermined time has elapsed after the transmission packet of the automatic setting request issued from the wireless image server apparatus 20 had been broadcasted, even when a transmission packet of a response with respect to the automatic setting request is transmitted from the router apparatus 10, this transmission packet is neglected. After the setting information has been stored, the wireless image server apparatus 20 notifies such a message that the automatic setting operation is accomplished from a display means (not shown) and/or a voice output means (not shown), and furthermore, broadcasts this stored setting information to the port number 10667 (33). When the control means 16 of the router apparatus 10 receives the setting information from the wireless image server apparatus 20, this control means 16 judges as to whether or not the received setting information is made coincident with the setting information corresponding to the wireless image server apparatus 20, which has been stored in the storage means 14. When the control means 16 judges that these setting information is made coincident with each other, the control means 16 displays a completion of the automatic setting operation on the display means 15, and also, outputs a warning sound for notifying the completion of the automatic setting operation from the voice output means (not shown), and then, accomplishes the automatic setting operation.

It should also be noted that the notification for notifying such a message that the automatic setting operation is accomplished by the wireless image server apparatus 20 may be alternatively carried out after the outer apparatus 10 has accomplished the automatic setting operation, and then, the packet of the automatic setting completion message transmitted by the router apparatus 10 is received.

The update confirming operation is performed in such a manner that the information of the data portion of the received transmission packet is compared with the information (namely, information corresponding to transmission source MAC address of transmission packet). The subjects to be compared with each other are values of IP addresses, sub-net masks, port numbers, and bandwidths. In the case that these comparison subjects are identical to each other, the router apparatus 10 judges that these subject values need not be updated, and thus accomplishes the automatic setting operation. In the case that these comparison subjects are different from each other, such a transmission packet which contains the information (namely, information corresponding to transmission source MAC address of transmission packet) stored in the storage means 14 is transmitted with respect to the transmission source MAC address by employing the UDP protocol. Subsequently, since process operations of this update confirming operation are similar to those of the automatic updating operation, explanations thereof are omitted.

After the automatic setting operation has been ended, since both a global IP address of the router apparatus 10 and a port number of the wireless image server apparatus 30 are designated from a client PC (personal computer) side which is connected to an external network such as the Internet (S4), the router apparatus 10 judges as to whether or not there is such a terminal apparatus corresponding to a port number which is contained in a transmission packet transmitted from the external network based upon the information stored in the storage means 14. In the case that there is the terminal apparatus corresponding to this port number, the router apparatus 10 forwards the transmission packet sent from the client PC with respect to an IP address of this terminal apparatus (namely, wireless image server apparatus 20). Then, the forwarded transmission packet is received by the wireless image server apparatus 20 (S5) It should also be understood that as to a communication quality such as a communication band, the communication quality is maintained in accordance with a communication quality level which has been stored in the storage means 14 of the router apparatus 10.

Next, an automatic setting operation as to both wireless setting information and network setting information of the wireless adoptor apparatus 30 will now be described with reference to a sequence diagram of FIG. 8.

In order to perform operations in the automatic setting mode, first of all, the operation mode of the wire LAN interface 11a is switched to the automatic setting mode by operating the switching means 17 of the router apparatus 10. Also, the operation mode of the wire LAN interface 34 is switched to the automatic setting mode by operating the switching means 36 of the wireless adoptor apparatus 30. Then, as shown in FIG. 4, both the wire LAN interface 11a of the wireless apparatus 10 and the wire LAN interface 34 of the wireless adaptor apparatus 30 are connected to each other by way of such a cable as 100BASE-T.

Operations defined in steps S11 to S13 are basically identical to those of the above-described steps S1 to S3. However, in the case of the wireless adaptor apparatus 30, since no network setting information is required, the router apparatus 10 transmits only wireless setting information. As to this operation, the control means 16 makes a judgement based upon a MAC address of the wireless adaptor apparatus 30. Also, in the step S12, only the wireless setting information is transmitted from the router apparatus 10 (namely, network setting information is not transmitted). As a consequence, also in the step S13, only the wireless setting information is transmitted from the wireless adaptor apparatus 30.

Next, the operation mode of the wire LAN interface 34 is switched to a LAN operation mode by operating the changing switch 36 of the wireless adaptor apparatus 30, and then, the wireless LAN interface is connected to the computer apparatus 50 via such a cable of 100BASE-T.

Then, operations defined in steps S14 to S16 are carried out, and then, the automatic setting operation of the computer apparatus 50 is accomplished. Operations defined in steps S14 to S16 are basically identical to those of the above-described steps S1 to S3. However, in the case of the computer apparatus 50, since no wireless setting information is required, the router apparatus 10 transmits only network setting information. As to this operation, as previously explained, the control means 16 makes a judgement based upon the MAC address of the wireless adaptor apparatus 30. Also, in the step S15, only the network setting information is transmitted from the router apparatus 10 (namely, wireless setting information is not transmitted) As a consequence, also in the step S16, only the network setting information is transmitted from the wireless adaptor apparatus 30.

Also, since operations after the automatic setting operations of both the wireless adaptor apparatus 30 and the computer apparatus 50 are basically identical to the operations defined in the steps S4 and S5, explanations thereof are omitted (S17 and S18).

Next, a description will be made of operations of the router apparatus 10 in the automatic setting mode based upon a flow chart of FIG. 10. It should also be noted that since explanations as to process operations of this automatic setting mode are partially overlapped with the above-described explanations of the flow charts shown in FIG. 7 and FIG. 8, a portion of this overlapped explanation is omitted in the following descriptions.

First, the router apparatus 10 judges as to whether or not a transmission packet is received at the port number 10667 (S20). When the control means 16 of this router apparatus 10 judges that the transmission packet has been received, this control means 16 automatically produces network setting information, wireless setting information, and the like with respect to an apparatus of a packet transmission source (S21), and further, stores the produced setting information into the storage means 14 in correspondence with a transmission source MAC address (S22).

When the storing operation to the storage means 14 is accomplished, the control means 16 broadcasts the setting content stored in this storage means 14 to another port number 10668 (S23). Thereafter, the control means 16 waits that the setting information is broadcasted to the port number 10667 from such an apparatus which has broadcasted the setting information in the above-described step S21 (S24). It should also be noted that the control means judges as to whether or not such an apparatus which has transmitted the setting information is identical to the apparatus in the step 521 based upon a MAC address.

When the control means 16 judges that the setting information has been transmitted from the same apparatus, this control means 16 judges as to whether or not the transmitted setting information is made coincident with the setting information stored in the storage means 14 (S25). If the transmitted setting information is not made coincident with the stored setting information, the control means 16 executes an error process operation (S26). On the other hand, when the control means 16 judges that the transmitted setting information is identical to the stored setting information, the control means 16 displays such a message that the automatic setting operation is ended on the display means 15 (S27).

In this connection, a detailed content as to the automatic producing operation of the setting information defined in the step 521 will now be explained with reference to a flow chart of FIG. 11.

The control means 16 derives a transmission source MAC address from the broadcasted transmission packet (S30), and judges as to whether or not this derived MAC address corresponds to a predetermined MAC address which has been stored in the storage means 14 (S31). When the control means 16 judges that this derived MAC address is equal to the predetermined MAC address, the control means 16 automatically produces the wireless setting information (S32). On the other hand, the control means 16 judges that the derived MAC address is not equal to the predetermined MAC address, the control means 16 automatically produces the automatic setting information (S33), and further, automatically produces the network setting information (S34), and then accomplishes the production of the setting information.

Also, an automatic producing operation of the wireless setting information will now be explained with reference to a flow chart of FIG. 12. The control means 16 derives a MAC address of the own router apparatus 10, and executes a predetermined calculation as to this derived MAC address so as to automatically produce encryption information such as an encryption code (S35), and furthermore, to automatically produce an SSID (S36). Thereafter, the control means 16 judges a communication quality level corresponding to the transmission source MAC address, and then, stores this judged communication quality level into the storage means 14 in relation to the MAC address (S37).

Next, a description is made of process operations of the wireless image server apparatus 20 in the automatic setting mode with reference to a flow chart shown in FIG. 13.

First, the control means 37 judges as to whether or not the changing switch 36 has been switched to the side of the automatic setting mode (S40). In such a case that the control means 37 judges that the changing switch 36 has not yet been changed to the automatic setting mode side, the control means 37 is operated as the normal N interface (S41). In other words, the control means 37 is brought into such an operation condition that the control means 37 receives a request for transmitting a Web page and image data issued from a client terminal which is connected to a network, and then, transmits data corresponding to this transmission request. On the other hand, in the case that the control means 37 judges that the changing switch 36 has been switched to the automatic setting mode side, operations/controls by the automatic setting control means 37a are subsequently carried out. The automatic setting control means 37a judges as to whether or not the wire LAN interface 34 is connected to either a network or another apparatus (S42) It should also be understood that this judging operation is carried out by checking as to whether or not a link pulse is received by the wireless LAN interface 34.

In such a case that the automatic setting control means 37a judges that the wireless LAN interface 34 is connected to the network, or the like, the automatic setting control means 37a derives storage information of a predetermined area of the storage means 35 (S43), and then, broadcasts this derived information (namely, network setting information and wireless setting information) by designating the port number 10667 from the wire LAN interface 34 (S45). Thereafter, such a transmission packet which contains the setting information broadcasted from the network, or the like is received by the wire LAN interface 34 (S45), and then, such setting information as the network setting information and the wireless setting information, which are contained in this transmission packet, are stored in the storage means 35 (S46), and then, a reinitiating operation is performed (S47). Thereafter, the automatic setting control means 37a broadcasts the setting information which has been stored in the predetermined storage area of the storage means 35 by designating the port number 10667 (S47), and then accomplishes the automatic setting operation.

While such an operation that a transmission packet is broadcasted to the port number 10667 is used as a trigger, the operation mode of the router apparatus 10 may be alternatively transferred to the automatic setting mode. In this alternative case, the changing switch 17 is no longer required.

Also, the above explanation has been made in such a manner that the wire interfaces of the router apparatus 10, the wireless image server apparatus 20, and the wireless adaptor apparatus 30 have been switched to the automatic setting modes by operating the respective switch changing means. Alternatively, a wire interface which is exclusively used to execute the automatic setting operation may be separately provided irrespective of the wire interface which is operated in the normal LAN operation, and the changing means may be dismounted.

Also, in FIG. 13, the operations of the wireless image server apparatus 20 have been explained. The operation of the wireless adaptor apparatus 30 may also be similar to that of the wireless image server apparatus 20 in principle.

Also, in the embodiment mode 1 of the present invention, such a description has been made in which the apparatus which is connected to the wireless adaptor apparatus corresponds to the computer apparatus and the wire image server apparatus. However, the present invention is not limited only to this example. Alternatively, if any sorts of apparatus capable of being connected in a wire LAN are present, then a video recorder, a television set, a game apparatus, and the like may be employed. Further, the present invention is not similarly limited only to the wireless image server apparatus. Alternatively, if any sorts of apparatus capable of being connected in a wireless LAN are present, then a video recorder, a television set, a game apparatus, and the like may be employed.

### Embodiment Mode 2

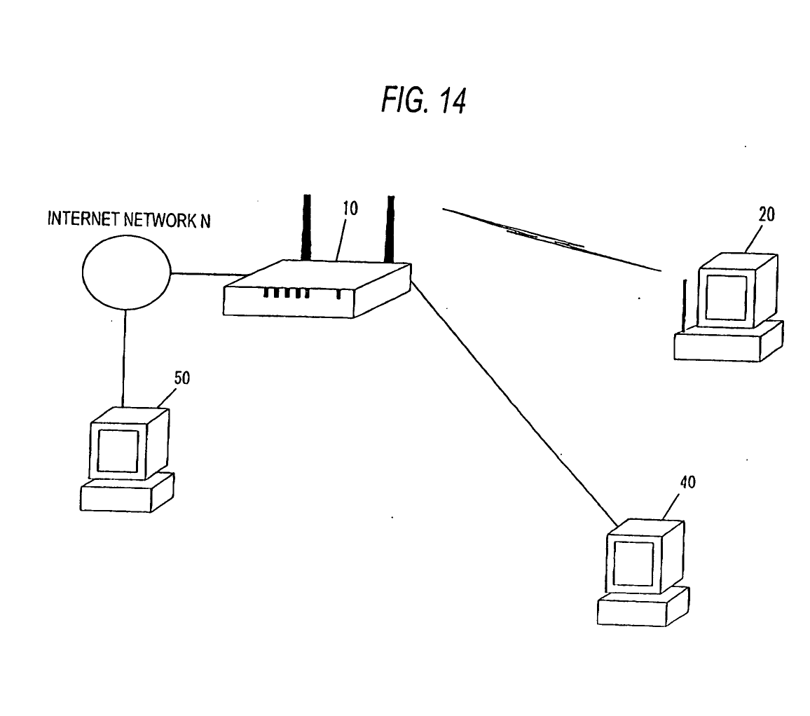

FIG. 14 shows a structural diagram of a network system according to an embodiment mode 2 of the present invention.

In FIG. 14, reference numeral 10 shows a router apparatus (namely, wireless access point of present invention) which is connected to a wide area network (WAN) such as the Internet “N”. This router apparatus 10 owns a function capable of routing a communication packet which is transmitted from a terminal connected to a local network, and also, another function operable as a wireless access point. The router apparatus 10 owns both an interface adapted to a wireless LAN specification (IEEE802.11b etc.), and also, another interface adapted to a wire LAN specification (IEEE802.3).

Reference numeral 20 indicates a computer apparatus which is adapted to a wire LAN specification, and can be communicated to a relay apparatus by employing the TCP/IP protocol, or the like. Also, a wireless LAN card unit 24 which is adapted to a wireless LAN specification may be connected to this computer apparatus 20. Further, the computer apparatus 20 may be communicated via the router apparatus 10 to an apparatus provided on the side of the Internet “N”, and a LAN terminal 40.

Reference numeral 40 shows a LAN terminal which is adapted to a wire LAN specification, and can be connected via a wire cable and the router apparatus 10 to another apparatus.

Reference numeral 50 represents a Web server which resends a Web page and the like in response to a request issued from the computer apparatus 20 and another request issued from the LAN terminal 40.

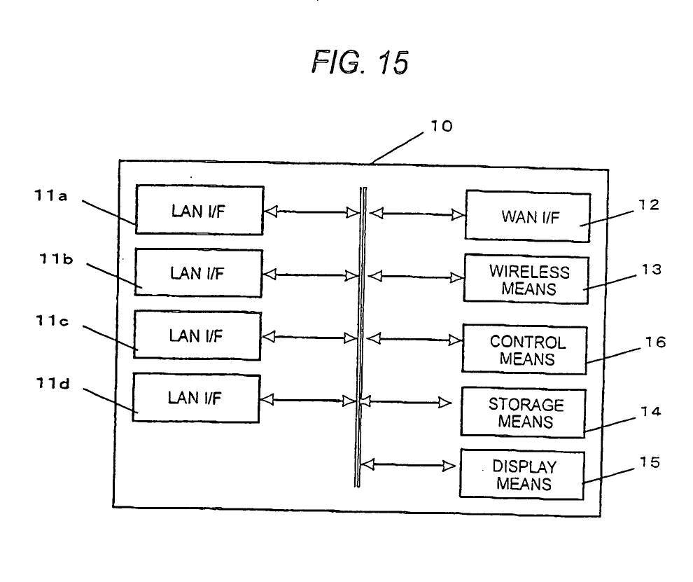

FIG. 15 represents an internal structural diagram of the router apparatus 10 according to the embodiment mode 2 of the present invention.

In FIG. 15, reference numerals 11a to lid indicate TAN I/F which are used to be communicated to a terminal apparatus (LAN terminal 40, computer apparatus 20, and so on) which constitutes a private network. The LAN I/F (interfaces) are adapted to such a LAN specification as IEEE802.3 (CSMA/CD), and correspond to interfaces capable of being connected to such a wire cable as 100BASE-T. Reference numeral 12 indicates a WAN I/F used to be communicated to an external network such as the Internet. This WAN I/F 12 is adapted to such a LAN specification and corresponds to an interface capable of being connected to such a cable as 100BASE-T. It should also be noted that the WAN I/F 12 may be realized by another interface which is communicatable with ADSL and ISDN other than an interface adaptable with the LAN specification. Also, the router apparatus 10 may transfer a packet received by the WAN I/F 12 to a terminal apparatus which is connected to the wire LAN interface 11 by way of a port forward function, and conversely, may convert a packet which is transmitted from the terminal apparatus into an IP address by way of a NAT function, and then, may transfer this IP address to an external network. Also, the terminal apparatus which is connected to the wire LAN interface 11 constitutes a private network, and can be communicated among respective terminals by employing local IP addresses.

Reference numeral 13 shows a wireless means. This wireless means 13 contains a wireless circuit used to be communicated to a terminal apparatus which constitutes a private network, and is adapted to such a wireless LAN specification as IEEE802.11b, and also is communicated to the terminal apparatus (computer apparatus 20 etc.) in a wireless manner. It should also be noted that this wireless means 13 owns such a function operable as a wireless access point which is communicatable between the own wireless means 13 and a wireless client such as the computer apparatus 14.

Reference numeral 14 represents a storage means for storing therein to a control program and various sorts of setting information, and also, storing thereinto network setting information of various terminal apparatus, wireless setting information, and the like (will be referred to as “setting information” by combining network setting information with wireless setting parameter information hereinafter), and further stores thereinto a port forward table for a port forward.

Reference numeral 15 shows a display means such as an LCD and an LED. Reference numeral 16 denotes a control means for controlling an entire system of a wireless apparatus.

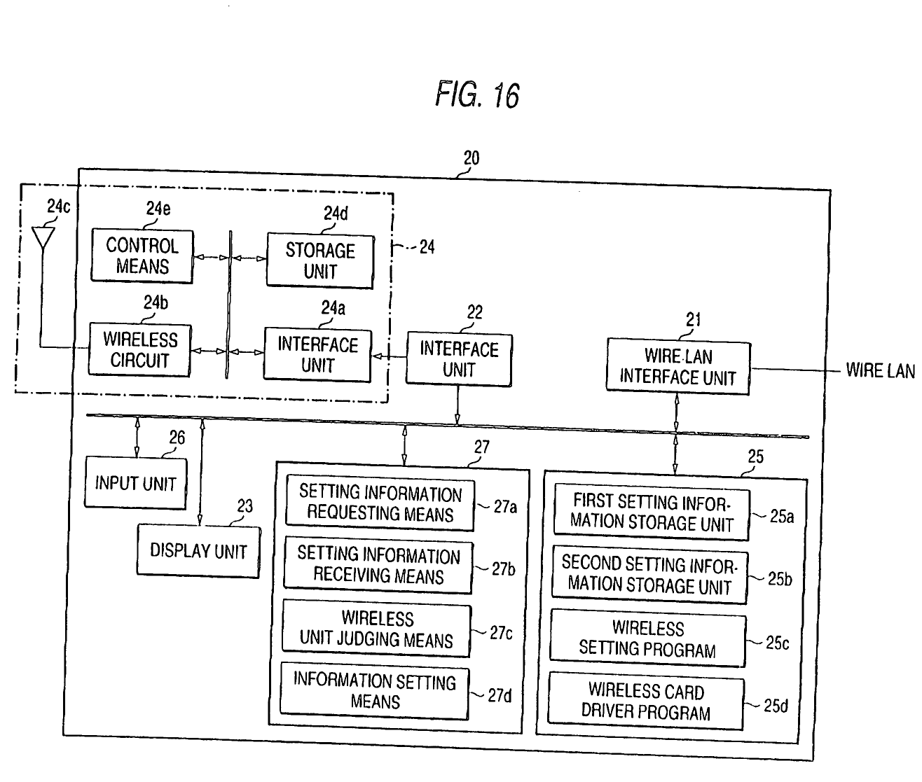

FIG. 16 shows a structural diagram of the computer apparatus 20 according to the embodiment mode 2 of the present invention.

In FIG. 16, reference numeral 21 indicates a wire LAN interface used to perform a wire communication with respect to the router apparatus 10 and the LAN terminal 40. This wire LAN interface 21 is adapted to such LAN specification as IEEE802.3(CSMA/CD), and is connectable to such a cable as 100BASE-T. Reference numeral 22 represents an I/F unit which is connectable to a PCMCIA bus and/or a USB bus. Reference numeral 23 indicates a display unit for displaying thereon a character, an image, and the like. Reference numeral 24 shows a wireless LAN card used to execute a wireless communication operation with the router apparatus 10 which constitutes a private network in accordance with a wireless LAN specification (IEEE802.11b etc.) This wireless LAN card 24 is connected via the I/F unit 22 to the computer apparatus 20.

Reference numeral 24a indicates a wireless LAN card interface unit which is connected via the I/F unit 22 to the computer apparatus 20, and is constituted by a PCMCIA bus, or a USB bus. Reference numeral 24b indicates a wireless circuit for transmits/receives a wireless signal in accordance with a wireless LAN specification (IEEE802.11b etc.). Reference numeral 24c shows an antenna which is connected to the wireless circuit 24b and is used to transmit/receive a wireless signal. Reference numeral 24d shows a storage means capable of storing thereinto setting information (wireless setting parameter information) of various sorts of parameters which are required in a wireless communication operation. Reference numeral 24e is a control means for controlling an entire system of the wireless LAN card 24.

Reference numeral 25 indicates a storage unit for storing thereinto wireless setting parameter information, a wireless setting program, a wireless card driver program, and the like.

Reference numeral 25a indicates a first setting information unit capable of storing thereinto wireless setting parameter information. The first setting information storage unit 25a is used in order to temporarily store thereinto the wireless setting parameter information transmitted from the router apparatus 10 in such a case that either a wireless LAN card connected to the computer apparatus 20 or a wireless unit (will be referred to as “wireless unit” hereinafter) built in a computer apparatus is not equal to both a maker name and a product name (will be referred to as “predetermined wireless unit” hereinafter) which have been previously determined. It is so assumed that in the embodiment mode 2 of the present invention, for the sake of easy convenient explanations, the wireless LAN card 24 corresponds to the “predetermined wireless unit”, whereas a wireless LAN card other than this wireless LAN card 24, and the wireless unit built in the computer apparatus 20 (see FIG. 4) are not equal to both the maker name and the product name, which have been previously determined.

Also, reference numeral 25b shows a second setting information storage unit capable of storing thereinto wireless setting parameter information. The second setting information storage unit 25b is used to temporarily store thereinto the wireless setting parameter information transmitted from the router apparatus 10 in such a case that the wireless LAN card 24 is not present.

Reference numeral 25c shows a wireless setting program. This wireless setting program 25c corresponds to such a computer program which is read out from the storage unit 25 under control of a control means 27 (will be explained), and causes the computer apparatus 20 to function as a setting information requesting means 27a, a setting information receiving means 27b, a wireless unit judging means 27c, and an information setting means 27d, which will be described later.

Reference numeral 25d shows a wireless LAN card driver program. The wireless LAN card driver program 25d is read out from the storage unit 25 under control of the control means 27 (will be explained later), and functions as a transmitting/receiving means for transmitting/receiving information as to the control means 27 (containing information setting means 27d) and the control means 24e of the wireless LAN card 24.

Reference numeral 26 shows an input unit such as a keyboard and a mouse.

Reference numeral 27 represents a control means for controlling an entire system of the computer apparatus 20.

Reference numeral 27a indicates a setting information requesting means. This setting information requesting means 27a owns such a function that a communication packet is broadcasted via the wire LAN interface unit 21 by way of the UDP protocol. This communication packet contains such a data for requesting to transmit both wireless setting parameter information and network setting information, which are used so as to be wireless-communicated to the router apparatus 10 as a wireless access point.

Reference numeral 27b shows a setting information receiving means. This setting information receiving means 27b owns such a function that both the wireless setting parameter information and the network setting information, which are broadcasted from the router apparatus 10 by way of the UDP protocol, are received via the wireless LAN interface unit 21. It should also be noted that if such a multicast address is defined which is commonly used between a computer and a router having a wireless function and both the router and the computer can transmit and receive, then a multicast transmission may be carried out instead of the broadcast transmission. Also, a router having a wireless function may be similarly operated even in a wireless access point which bridges both a wireless unit and a wire unit.

Reference numeral 27c shows a wireless unit judging means which owns a function for judging as to whether or not a wireless unit is present in a computer. For example, the wireless unit judging unit 27c judges as to whether or not the wireless LAN card 24 is connected to the I/F unit 22 in such a way that a presence confirming signal is transmitted from the I/F unit 22, and then this wireless unit judging means 27c judges as to whether or not a response as to this presence confirming signal is made. Alternatively, the wireless unit judging means 27c may judge as to whether or not the wireless LAN card 24 is connected to the I/F unit 22 in such a manner that the control means 27 detects as to whether or not the wireless LAN card 24 is connected to the I/F unit 22, and refers to connected card information which has been stored in the storage unit 25.

Reference numeral 27d shows an information setting means which owns such a function that when the wireless unit judging means 27c judges that the wireless unit is present, the information setting means 27d sets the wireless parameter information received by the setting information receiving means 27b. This setting operation of the wireless parameter information is carried out as follows. That is, if a wireless unit corresponds to the predetermined wireless unit, then the wireless setting parameter information is set to the storage unit of the wireless unit, whereas if a wireless unit does not correspond to the predetermined wireless unit, then the setting information receiving means 27b judges the wireless system of the wireless unit, and thereafter, stores only such a wireless parameter information corresponding to this wireless system among the received wireless setting parameter information into the first setting information storage unit 25a. The setting operation of the wireless parameter information to the storage unit of the wireless unit is carried out as follows: For instance, in such a case that the wireless unit corresponds to the wireless LAN card 24, the wireless parameter information is stored into the storage unit 24d by way of a wireless card driver functioning as the transmitting/receiving means.

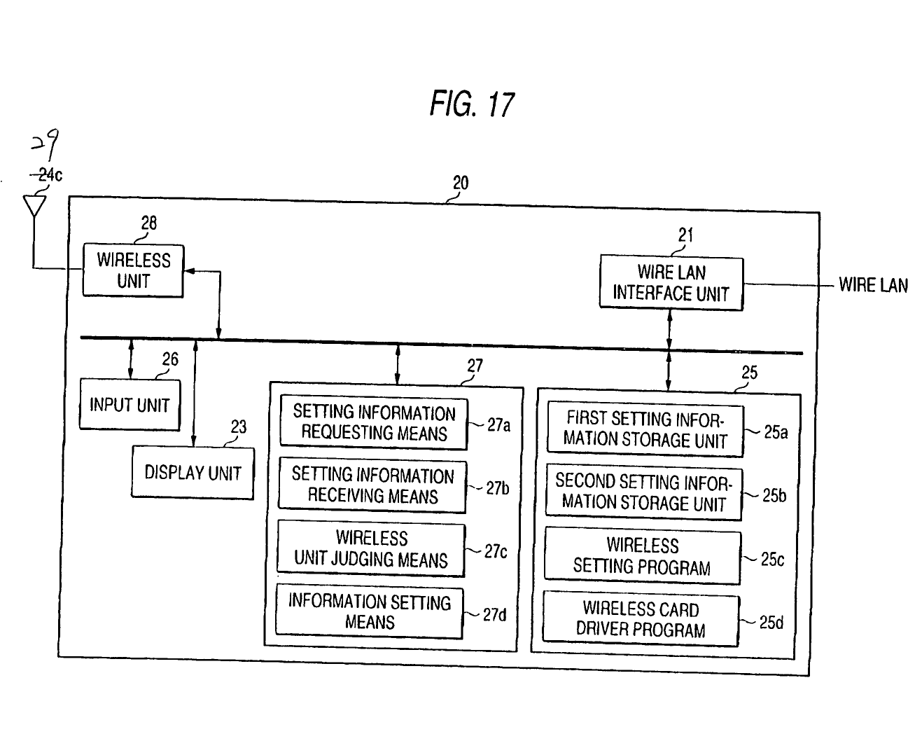

FIG. 17 shows a structural diagram of a computer apparatus 20 which contains a wireless LAN unit, according to the embodiment mode 2 of the present invention. A technical different point of this computer apparatus 20 from that of the computer apparatus 20 shown in FIG. 16 is only such a aspect as to whether or not the wireless LAN unit is built in the computer apparatus 20.

That is to say, since the structures of the wireless LAN card 24 and the I/F unit 22 of FIG. 16 are merely replaced by both a wireless unit 28 and an antenna 29, explanations thereof are omitted.

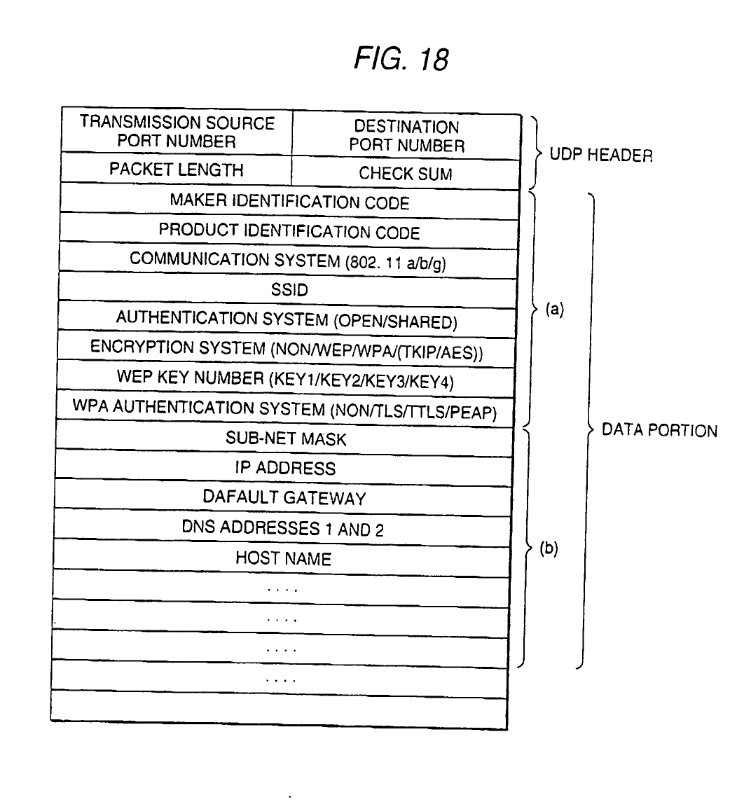

FIG. 18 represents a UDP packet structural diagram of setting information which is transmitted from the router apparatus 10 according to the embodiment mode 2 of the present invention.

The UDP packet is constructed of both a UDP header portion and a data portion. Both wireless setting parameter information (a) and network setting information (b) are contained in the data portion. In such a case that a request issued from the commuter apparatus 20 is only the wireless setting parameter information, there are some cases that the network setting information (b) is not contained in the data portion. A detailed content of the data portion will now be described.

A maker identification code implies such an information indicative of a maker of a product. A product identification code implies such an information which is specifically allocated to each of products, and which also contains a serial number in addition to a product number. A communication system corresponds to such an information of a wireless system, and which indicates that wireless setting parameter information corresponds to any one of information as to IEEE802.11a, IEEE802.11b, and IEEE802g. It should be understood that this wireless setting parameter information is such an information as to in the case of only IEEE802.11a, or such an information as to in the case of all of IEEE802.11a, 11b, and 11g.

Symbol “SSID” implies one of technical specifications which are defined in the IEEE802.11 wireless LAN specification. This SSID is used to cause a wireless LAN terminal apparatus (child appliance) such as the computer apparatus 20 to recognize presence of a wireless access point (mother appliance) such as the router apparatus 10. It should be also understood that when an SSID of a wireless LAN terminal apparatus is not made coincident with an SSID of a wireless access point, a wireless communication cannot be carried out.

An authentication system indicates such a condition for indicating as to whether or not a password is used when a first connecting operation is commenced in a connection protocol with respect to an access point. An encryption system indicates a data encryption system executed when communication data is actually transmitted in a wireless system after a connection to an access point has been established. The WEP (RC4) system, TKIP, AES, and the like may be utilized as this data encryption system. When the WEP system is utilized, four keys (encrypt key=decrypt key) can be registered at maximum. Both values and key numbers of these four keys must be made coincident with each other on the encryption side and the decryption side. In this WEP system, this key number is called as a “WEP key number”. WPA (Wi-Fi Protected access) corresponds to emphasized security of the Wi-Fi specification defined in the Wi-Fi alliance. A WPA authentication system is to define a user authentication system used in WPA, and, as an example, non-authentication/PSK (Pre Shared Key: common key) EAP-TLS, and the like may be exemplified.

Also, the network setting portion of the network setting information (b) is similar to such a parameter which is allocated by a so-called “DHCP (Dynamic host Configuration control) server to a DHCP client (corresponding to computer apparatus 20 in this embodiment mode 2 of present invention). There are various sorts of parameters such as a sub-net mask of a network, and an IP address of a client. For example, as to an IP address, when network setting information is requested from the commuter apparatus 20, the router apparatus 10 judges such an IP address which may be allocated, and then sets this allocatable IP address as the data of the network setting portion.

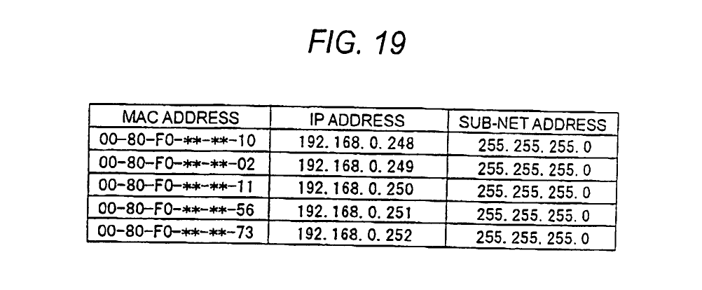

FIG. 19 is a diagram for indicating a network setting information table of the router apparatus 10 according to the embodiment mode 2 of the present invention. In this table, MAC addresses, IP addresses, and sub-net masks of terminal apparatus to which the router apparatus 10 has allocated the network setting information have been stored. It should also be noted that this network setting information table has been stored in the storage means 14.

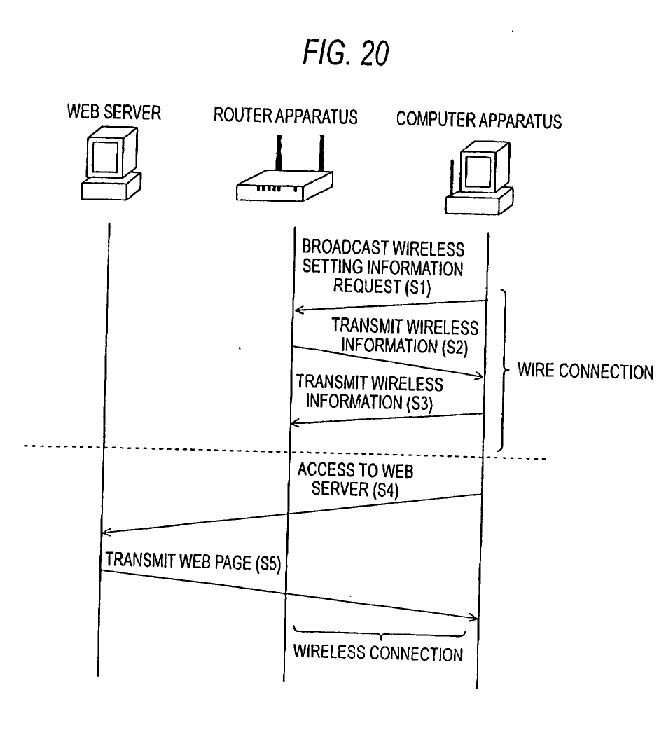

FIG. 20 is a diagram for indicating an operation sequence of the computer apparatus 20 according to the embodiment mode 2 of the present invention. With reference to FIG. 20, the operations of the computer apparatus 20 will now be briefly explained.

The computer apparatus 20 is connected via the wire LAN interface unit 21 to the wire LAN interface unit 11 of the router apparatus 10 by using a wire cable. Under this condition, the computer apparatus 20 broadcasts a request of wireless parameter information as a UDP packet through the wire LAN interface unit 21 (S1) When the wireless parameter information request which will be broadcasted is received by the router apparatus 10, the router apparatus 10 broadcasts the wireless setting parameter information stored in the storage unit 25 as a UDP packet (refer to FIG. 19) via the wire LAN interface unit 11 (S2). When the computer apparatus 20 receives the wireless setting parameter information which will be boradcasted, this computer apparatus 20 sets a wireless parameter information of the wireless unit (namely, wireless LAN card 24 and wireless unit 28) of the computer apparatus 20 based upon the received wireless parameter information. Then, the computer apparatus 20 transmits the wireless setting parameter information as a response thereof to the router apparatus 10 (S3)

After the wireless parameter information of the wireless unit of this computer apparatus 20 has been set in this manner, if the wire cable of the wire LAN interface unit 21 of the computer apparatus 20 is removed, then this computer apparatus 20 establishes a connection with respect to the router apparatus 10 in a wireless communication manner by the wireless unit. For instance, when the computer apparatus 20 accesses the Web server 50, this access request is sent via the wireless unit of the computer apparatus 20 to the wireless means 13 of the outer apparatus 10, and further, is transmitted via the WAN I/F 12 of the router apparatus 10 to the Web server 50 (S4). When the Web server 50 receives the access request, the Web server 50 transmits a Web page of a portal site to the computer apparatus 20, and then, this Web page is transmitted via the wireless means 13 of the router apparatus 10 to the wireless unit of the computer apparatus 20. Thereafter, the Web page is displayed on the display unit 23 under control of the control means 27 of the computer apparatus 20 (S5).

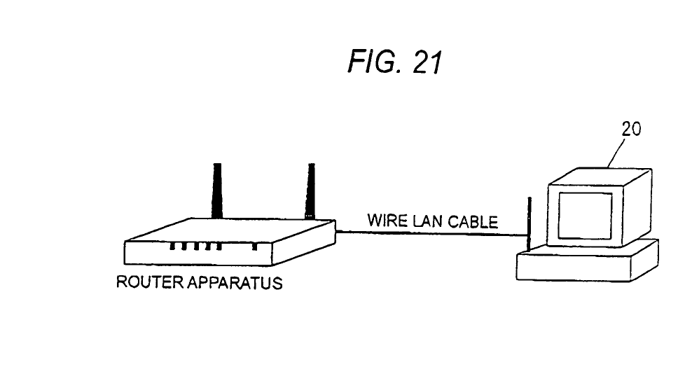

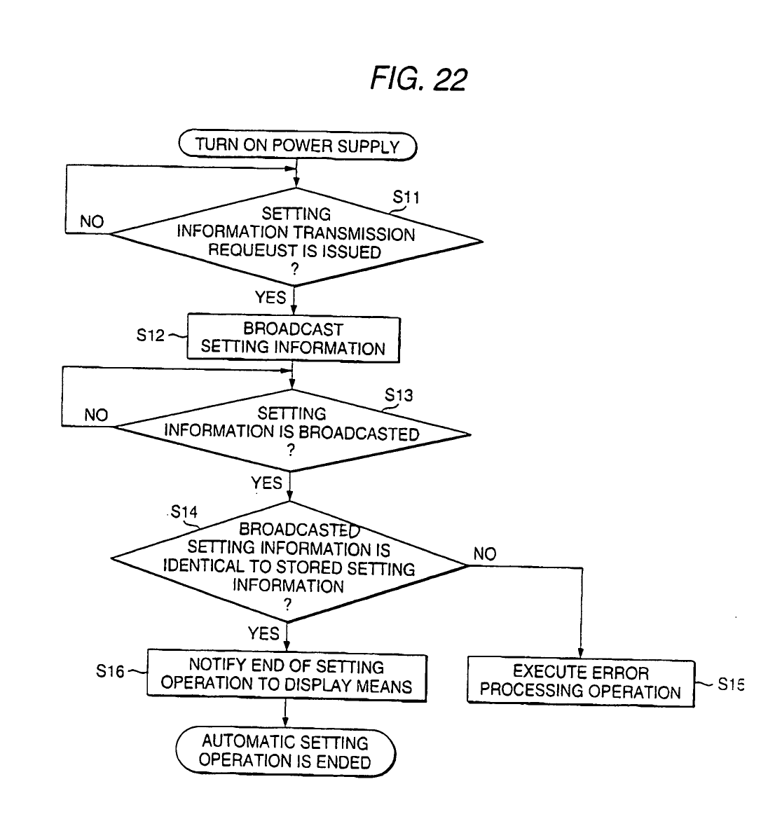

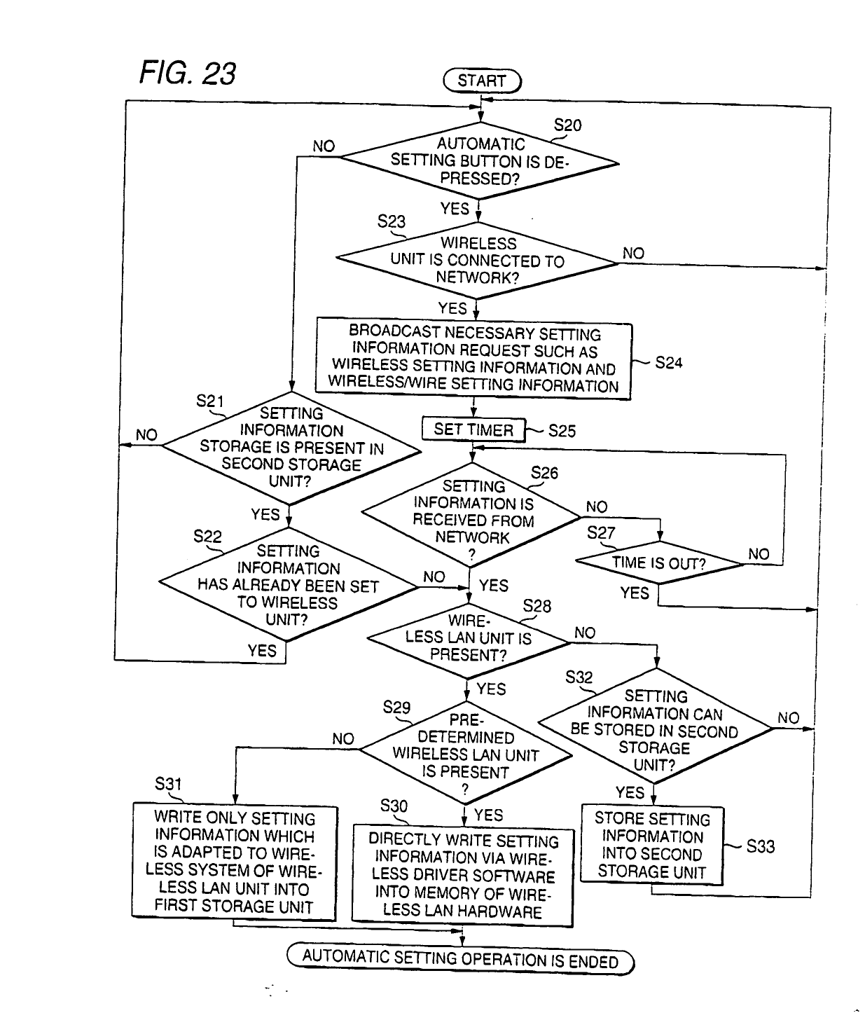

Subsequently, operations of both the router apparatus 10 and the computer apparatus 20, according to the embodiment mode 2 of the present invention, will now be described with reference to flow charts of FIG. 22 and FIG. 23. It is so assumed that both the router apparatus 10 and the computer apparatus 20 are brought into such a condition, namely, as shown in FIG. 21, the wire LAN interface unit 11 of the router apparatus 10 is connected to the wire LAN interface unit 21 of the computer apparatus 20.

FIG. 22 is a flow chart for explaining setting operations of the router apparatus 10 according to the embodiment mode 2 of the present invention. FIG. 23 is a flowchart for describing setting operations of the computer apparatus 20 according to the embodiment mode 2 of the present invention.

First, a description is made of a parameter setting operation by the router apparatus 10 based upon the flow chart of FIG. 22.

When the operation is commenced, the control means 16 of the router apparatus 10 judges as to whether or not a request for transmitting the setting information is transmitted in a broadcast manner via the wire LAN interface unit 11 (S11). When the control means 16 judges that the request for sending the setting information has been broadcasted, the control means 16 judges as to whether this setting information transmitting request corresponds to either a request for transmitting only the wireless setting parameter information, or another request for transmitting the network setting information in addition to this wireless setting parameter information. As a result of the judgement, in such a case that the control means 16 judges that this request corresponds to the request for sending only the wireless setting parameter, the control means 16 derives such an information related to the portion (a) within the data portion of FIG. 18 from the storage means 14, and then sets this derived information as setting information to be transmitted. On the other hand, in the case that the control means 16 judges that this request corresponds to the request for sending the network setting information in addition to the wireless setting parameter information, the router apparatus 10 selects such an IP address which can be allocated by judging from the network setting information table of FIG. 19, and the control means 16 derives other information from the storage means 14, and thereafter sets the derived information as setting information (namely, data portions (a) and (b) of FIG. 18) for transmission purpose. It should also be noted that the generation of the IP address is carried out in such a manner that an IP address which is not used by another terminal appliance and can be allocated is generated by that the control means 16 refers to the network setting information table of FIG. 19. After the IP address has been allocated, the control means 16 of the router apparatus 10 stores both this IP address and a MAC address of the IP address-allocated terminal apparatus into the network setting information table of FIG. 19 in relation to each other.

Subsequently, the control means 16 transmits the setting information for transmission purpose from the wire LAN interface unit 11 by using the UDP protocol to the network either in a unicast transmission mode or a broadcast transmission mode (S12). Thereafter, when the control means 16 judges that a response with respect to the transmission of the step S12 has been transmitted to the router apparatus 10 in either the unicast transmission mode or the broadcast transmission mode (S13), this control means 16 judges as to whether or not the setting information transmitted in the step S12 is identical to the setting information transmitted in the step S13 (S14). In such a case that this control means 16 judges that the setting information transmitted in the step S12 is not identical to the setting information transmitted in the step S13, the control means 16 executes an error process operation, and thus, notifies an occurrence of an error on the display means (S1). On the other hand, in such a case that this control means 16 judges that the setting information transmitted in the step S12 is identical to the setting information transmitted in the step S13, the control means 16 displays such a message that the automatic setting operation could succeed on the display means 15 (S16), and thus, accomplishes the automatic setting operation.

It should also be noted that as the operations of the router apparatus 10, only the setting operations defined in only the steps S11 and S12 may be alternatively carried out, but the setting operations defined in the steps S13 to S16 may not be alternatively carried out. If the setting operations are set in this alternative operation manner, then processing loads given to the router apparatus 10 may be reduced.

Next, a description is made of setting operations as to a wireless parameter of the computer apparatus 20 with reference to the flow chart shown in FIG. 23.

Since the input unit 26 of the computer apparatus 20 is operated, an initiating operation of the wireless setting program 25c stored in the storage unit 25 is instructed. When the control means 27 of the computer apparatus 20 receives such an instruction, the control means 27 starts the operation thereof in accordance with the wireless setting program 25c, and causes the display unit 23 to display thereon such a screen used to set the wireless parameter. At least two sets of automatic setting start buttons by way of a GUI (Graphic User Interface) are displayed on this screen used to set the wireless parameter, namely, an automatic setting button of the wireless parameter, and another automatic setting button of both the wireless parameter and the network parameter. The control means 27 judges as to whether or not the automatic setting start button is depressed (S20). When the control means 27 judges that the automatic setting start button is not depressed, this control means 27 judges as to whether or not the setting information has been stored in the second setting information storage unit 25b (S21). When the control means 27 judges that tie setting information has been stored in the second storage unit 25b, the control means 27 judges as to whether or not the wireless setting parameter information stored in the second setting information storage unit 25b has already been written in the wireless unit (S22). In this step, if the information setting means 27d judges that the wireless setting parameter information stored in the second setting storage unit 25b has already been written in the second setting information storage unit 25b, the setting operation of the information setting means 27d is advanced to the operation defined in the step S20. On the other hand, if the information setting means 27d judges that the wireless setting parameter information stored in the second setting storage unit 25b has not been written in the second setting information storage unit 25b, the setting operation of the information setting means 27d is advanced to the operation defined in the step S20.

When the control means 27, judges that the automatic setting start button is depressed in the step S20, the control means 27 detects as to whether or not a local network is connected to the wire LAN interface unit 21 (S23). It should be understood that this connection detecting operation is carried out in a physical layer level. Alternatively, this connection detecting operation may be carried out at a level higher than, or equal to the physical layer level.

Next, when the control means 27 judges that the local network is connected to the wire LAN interface unit 21, the setting information requesting means 27 a broadcasts such a UDP/IP packet via the wire LAN interface unit 24, while this UDP/IP packet contains in a data portion thereof, such a request that parameter setting information used to be communicated to the router apparatus 10 is transmitted (S24). In this step, the control means 27 changes the parameter information which is required to be transmitted in response to a sort of an automatic setting start button which is depressed. In other words, in the case that the automatic setting button of the wireless parameter is depressed, the setting information requesting means 27a requests to transmit such a request related only to the wireless parameter. On the other hand, in such a case that the automatic setting start button of both the wireless parameter and the wire parameter is depressed, the setting information requesting means 27a requests to send such a network setting information in addition to the wireless setting parameter information. This network setting information corresponds to an IP address, a sub-net mask, a DNS address, a default gateway, and the like.

Thereafter, the setting information receiving means 27b waits for a constant time duration such an operation that the setting information is broadcasted from the router apparatus 10 via the local network to the wire LAN interface unit 21 (S25 to S27). When the setting information transmitted from the router apparatus 10 is received by the wire LAN interface unit 21 during this constant time duration, the wireless unit judging means 27c judges as to whether or not a wireless unit (namely, wireless LAN hardware unit) is present (S28). For example, in such a case that the wireless LAN card 24 is connected to the I/F unit 22, the wireless unit judging means 27c judges that the wireless unit is present. Either in such a case that the wireless unit judging means 27c judges that the wireless unit is present or in the case that the control means 27 judges in the step S22 that the setting information has not been written in the wireless unit, the wireless unit judging unit 27c judges as to whether or not this wireless unit corresponds to a predetermined wireless unit (S29). In this step, the judgement as to whether or not the wireless unit corresponds to the predetermined wireless unit is made based upon a maker name and a product identification code, which have been stored in the storage unit 24d of the wireless LAN card 24.

In such a case that the wireless unit judging means 27c judges that the wireless unit corresponds to the predetermined wireless unit, the information setting means 27d initiates the wireless LAN card driver program 25c stored in the storage unit 25, and requests the wireless LAN card 24 via the wireless LAN card driver program 25c in order that the setting information received in the step S24 is set, and also, the control means 24e which has received this required via the wireless LAN card interface unit 24a stores the notified setting information into the storage unit 24d (S30). On the other hand, in such a case that the wireless unit judging means 27c judges that the wireless unit does not correspond to the predetermined wireless unit, the information setting means 27d discriminates a wireless communication system of the wireless unit, and selects only such a setting information which is adapted to the discriminated wireless communication system of the wireless unit from the setting information received in the step S24, and then, stores this selected setting information into the first setting information unit 25a. Then, when the setting information is stored in the first setting information storage unit 25a, the information setting means 27d transfers the setting information to the driver program for the wireless unit based upon the OS program, and then, the information setting means 27d sets the setting information to the wireless unit based upon this driver program (S 31).

On the other hand, in the case that the wireless unit judging means 27c judges that the wireless unit is not present in the step S25, the information setting means 27d judges as to whether or not the setting information has been stored in the second setting information unit 25b (S32). Then, in the case that the information setting means 27d judges that the setting information is not stored in the second setting information storage unit 25b, this information setting means 27d stores the setting information received in the step S24 into the second setting information storage unit 25b (S33).

It should also be noted that when the control means 27 judges that the setting information is not written in the wireless unit in the step S22, the control means 27 may alternatively cause the display unit 23 to display there on such a setting button for setting as to whether or not the setting information is written into the wireless unit. Thus, only when the setting button is depressed from the input unit 26, the setting operations defined from the step 528 may be alternatively commenced.

As previously described, in accordance with both the computer program and the computer apparatus of the embodiment mode 2 of the present invention, while the setting information used to set the parameters related to the wireless communication and the network is transmitted to the wireless access point such as the router apparatus, after the setting information transmitted from the wireless access point has been received, the computer program/computer apparatus judge as to whether or not the wireless unit is present in the computer. When the computer program/computer apparatus judges that the wireless unit is present, since the setting information received by the setting information receiving means is set to the wireless unit, in such a case that the wireless unit is present, the parameter used in the wireless communication can be readily set.

Also, in the case that the wireless unit is not present, since the received setting information is set to the first setting information storage means, even when the wireless unit is not present, the received setting information can be stored in the storage means. Thus, in such a case that the wireless unit is connected to the computer, the request for sending the setting information need not be newly issued.

Also, when the wireless unit is additionally provided after the setting information has been stored in the first setting information storage means, this setting information is derived from the first setting information storage means and then can be set to the added wireless unit. As a result, in such a case that the wireless unit is connected to the computer, there is such an effect that the request of sending the setting information and the setting information receiving process operation need not be newly carried out.

Also, even in such a case that the wireless unit is present, when the wireless unit is not matched with the wireless system contained in the received setting information, since the setting operation of the wireless parameter is not carried out, there is such an effect that the erroneous operation of the wireless unit can be prevented.

Also, since the setting information is required and received via the wire LAN interface, there is such an effect that the following problem can be avoided. That is, stolen of the wireless parameter can be avoided.

Further, since the setting information can contain the network setting information, the network setting operation can also be carried out in the easy manner.

Also, based upon the information of the input means, only such a necessary setting information can be requested to the wireless access point, which is selected from the wireless setting information, or the setting information further containing the network setting information. As a result, there is such an effect that the process operation can be readily carried out.

Furthermore, the subject of the setting information may be applied not only to the wireless communication, but also to an electric lighting line communication which requires a similar setting parameter. Also, similar effect may be achieved even in such a computer that an electric lighting line communication appliance is connected to a PC card slot, a USB port, a PCI slot, and the like, instead of a wireless communication appliance.

The present disclosure relates to subject matter contained in priority Japanese Patent Application No. 2003-111139 filed on Apr. 16, 2004 and No. 2003-380910 filed on Nov. 11, 2003, the content of which is herein expressly incorporated by reference in its entirety.

1. A wireless apparatus capable of being communicated to a plurality of terminal apparatus by a wireless manner, comprising:
a wire interface for being communicated to said terminal apparatus by a wire manner; and
control means for controlling a setting mode in which when said control means receives a transmit packet from said terminal apparatus connected to said wire interface and said transmit packet contains an address specific to said terminal apparatus, at least one of wireless setting information and network setting information is transmitted the terminal apparatus of said specific address.

2. A wireless apparatus as claimed in claim 1,
wherein said control means judges as to whether or not said at least one of said wireless setting information and said network setting information is transmitted based upon the specific address received from said terminal apparatus, and transmits said judged setting information to the terminal apparatus of said specific address.

3. A wireless apparatus as claims in claim 1 further comprising display means; and
wherein said control means causes said display means to display thereon such a fact that the transmission of said at least one of said wireless setting information and said network setting information is accomplished.

4. A wireless apparatus as claimed in claim 1, wherein said wire interface is exclusively used so as to perform an operation as said setting mode.

5. A wireless apparatus as claimed in claim 1, wherein the operation of said wire interface is switchable between the operation of said setting mode and an operation of a network interface.

6. A wireless apparatus as claimed in claim 6, wherein said wireless apparatus corresponds to a router apparatus; and said network interface corresponds to a wire LAN interface.

7. A wireless apparatus as claimed in claim 5, wherein said switching operation is carried out by way of a mechanical switch.

8. A wireless apparatus as claimed in claim 5, wherein in the case that a predetermined specific address is contained in said transmission packet, the operation of said control means is controlled in such a manner that only the wireless setting information is transmitted, but the network setting information is not transmitted.

9. A wireless apparatus as claimed in claim 1, wherein said wireless setting information corresponds to both encryption information and ID (identification) information.

10. A wireless apparatus as claimed in claim 9, wherein said control means automatically produces at least one of said encryption information and said ID information based upon the own specific address.

11. A wireless apparatus as claimed in claim 1, wherein said control means transmits at least one of said wireless setting information and said network setting information to the terminal apparatus, and also, stores said transmitted information to specific address storage means of said terminal apparatus.

12. A wireless apparatus as claimed in claim 10, wherein said control means performs a wireless communication operation with respect only to the terminal apparatus of the specific address which has been stored in said specific address storage means.

13. A wireless apparatus as claimed in claim 11, wherein said control means stores a communication quality level corresponding to said specific address into said storage means, and is communicated to the terminal apparatus in accordance with said stored communication quality level.

14. A wireless terminal apparatus comprising:
wireless communication control means for performing a wireless communication operation;
wire communication control means for performing a wire communication operation via a wire interface; and
first control means operated in such a manner that either when a power supply is turned ON or when a network, or another wireless terminal apparatus is connected to the wire interface, said first control means broadcasts the own specific address to either said network or said another wireless terminal apparatus in a predetermined interval, and thereafter, when said first control means receives wireless setting information transmitted from either said network or said another wireless terminal apparatus, said first control means stores said received wireless setting information into storage means.

15. A wireless terminal apparatus as claimed in claim 14, wherein after said first control means has stored said wireless setting information into the storage means, said first control means broadcasts said wireless setting information with respect to said network.

16. A wireless terminal apparatus as claimed in claim 14, wherein when said first control means received network setting information in addition to said wireless setting information, said fist control means stores the received network setting information into said storage means in addition to said wireless setting information.

17. A wireless terminal apparatus as claimed in claim 16, wherein after said first control means has stored both said wireless setting information and said network setting information into the storage means, said first control means broadcasts both said wireless setting information and said network setting information with respect to said network.

18. A wireless terminal apparatus as claimed in claim 14, further comprising switching means for switching the operations of said wire interface; and
wherein said wireless interface is operated as said first control means by operating said switching means.

19. A wireless terminal apparatus as claimed in claim 18, wherein said switching means is operated by a mechanical switch.

20. A wireless terminal apparatus as claimed in claim 14, wherein said wireless interface corresponds to a wire LAN (local area network) interface.

21. A wireless terminal apparatus as claimed in claim 14, wherein said wireless communication control means performs the wireless communication operation in accordance with the wireless setting information stored in said storage means.

22. A wireless system comprising:
a wireless apparatus recited in claim 1, and
a wireless terminal apparatus recited in claim 14.

23. A method for setting a wireless system containing a terminal apparatus and a wireless apparatus capable of communicating with the terminal apparatus in a wireless manner, comprising:
a step for connecting said terminal apparatus to said wireless apparatus in a wire manner;
a step in which said wireless apparatus receives a transmission packet via a wire line from said terminal apparatus, and said transmission packet contains a specific address of said terminal apparatus; and
a step in which said wireless apparatus transmits wireless setting information and/or wireless setting information via the wire line with respect to the terminal apparatus of said specific address.

24. A computer program for setting a parameter used to execute a communication operation with a wireless access point, wherein said computer program causes a computer to function as:
setting information requesting means for requesting to transmit setting information for performing said parameters setting operation with respect to said wireless access point;
setting information receiving means for receiving said setting information which is transmitted from said wireless access point;
wireless unit judging means for judging as to whether or not a wireless unit is present in said computer; and
setting means operated in such a manner that when said wireless unit judging means judges that the wireless unit is present, the setting information received by said setting information receiving means is set to said wireless unit.

25. A computer program as claimed in claim 24 wherein:
in the case that said wireless unit judging means judges that the wireless unit is not present, said setting means stores the setting information received by said setting information receiving means into a first storage means.

26. A computer program as claimed in claim 25, wherein in such a case that after said setting means has stored said received setting information into said first storage means, said wireless unit judging means judges that a wireless unit is additionally provided, said setting means derives said stored setting information from said first storage means and then sets said derived setting information to said additionally provided wireless unit.

27. A computer program as claimed in claim 24, wherein in such a case that even when the wireless unit is present, said wireless unit judging means judges that said wireless unit does not correspond to a wireless system which is contained in the setting information received by said setting information receiving means, said wireless unit judging means judges that the wireless unit is not present.

28. A computer program as claimed in claim 24, wherein both said setting information requesting means and said setting information receiving means transmit and receive either a request or information via a wire LAN interface with respect to said wireless access point.

29. A computer program as claimed in claim 24, wherein said setting information includes network setting information.

30. A computer program as claimed in claim 24, wherein said setting information requesting means requests any one of setting information containing wireless setting information, and setting information containing both said wireless setting information and further network setting information with respect to said wireless access point.

31. A computer apparatus comprising:
the computer program recited in claim 24.
